(19) United States
(12) Patent Application Publication
(10) Pub. No.: US 2026/0348812 A1
(43) Pub. Date: Nov. 5, 2026

(54) Microfluidic Viscometer and Methods of Use

(71) Applicant: JANSSEN RESEARCH & DEVELOPMENT, LLC, RARITAN, NJ (US)

(72) Inventors: Philippe Lenzen, Zurich (CH); Fabian Dingfelder, Konstanz (DE); Marius Mueller, Basel (DE); Paolo AROSIO, Zurich (CH)

(21) Appl. No.: 19/491,013

(22) PCT Filed: Dec. 7, 2024
(86) PCT No.: PCT/IB2024/055598

§ 371 Date: Dec. 8, 2025

Related U.S. Application Data
(60) Provisional application No. 63/506,975, filed on Jun. 8, 2023.

(51) Int. Cl. G01N 11/06

(52) U.S. Cl. CPC G01N 11/06

(57) ABSTRACT

A microfluidic viscometer includes a microfluidic viscometer including a microfluidic device having a glass layer and a PDMS layer attached on top of the glass layer and having a plurality of microfluidic channels each having inlets at one end and coupled to one another via a single chamber at distal end, the microfluidic channels configured to convey a plurality of fluids from respective inlets to the distal end, the plurality of fluids including at least one fluid with known viscosity and one or more fluids of interest with unknown viscosity, and an imaging device configured to acquire images of fluid flows within the microfluidic channels and having a viscosity measurement analyzer configured to calculate viscosity parameters of the plurality of fluids, analyze and compare the viscosity parameters, and measure the viscosity of the fluid of interest based at least in part on the viscosity parameters.

### FIELD OF THE INVENTION

The disclosed concept relates generally to an apparatus and method of measuring viscosity of fluids, more particularly to a microfluidic viscometer for automated and simultaneous measurement of multiple viscous fluids flowing through microfluidic channels of the viscometer.

### BACKGROUND OF THE INVENTION

Viscosity of fluid (e.g., liquid) is a measure of resistance of the fluid to flow. While the viscosity of Newtonian fluid (e.g., gases and water) does not vary significantly with a rate of deformation, viscosity of non-Newtonian fluids (e.g., shear-thickening liquid, shear-thinning liquids, thixotropic liquids and rheopectic liquids) depends on the rate of deformation. The rate of deformation is provided by a shear rate in a unit of time (t). Viscosity of chemical and biological fluids is a critical analytical parameter to evaluate in applications ranging from medical diagnostics to the chemical and biopharmaceutical industry. For example, in biopharmaceutical manufacturing, during development of high concentration antibody formulations, viscosity requires careful analysis to ensure the integrity and quality of the manufactured products, as well as their suitability for patient administration. Similarly, in the chemical industry, viscosity is integral in the fabrication of oil, lubricants, and paints to meet their specific requirements. In polymer rheology, it is also of particular interest for determining the molecular weights of polymers. Additionally, viscosity can also be employed as a diagnostic technique, where whole blood and plasma viscosity can be used as a marker of inflammation and cardiovascular health. Finally, in the food industry, the characterization of oil viscosity is used for the investigation of cooking oil degradation to evaluate its safety for consumption.

Viscosity measured at a known shear rate is referred to as true viscosity and viscosity measured without a known or uncalculatable shear rate (due to, e.g., ill-defined test settings) is referred to as apparent viscosity. However, since apparent viscosities are non-universal and designing processing materials, e.g., dies, molds, etc., requires knowledge of their true viscosity, numerous instruments for measuring true viscosity have been developed. For example, capillary tube viscometers have been developed to measure apparent and true viscosity. When using capillary tube viscometers, a fluid of interest flows under a known pressure difference and the velocity of the fluid in question is used to measure the viscosity. However, capillary tube viscometers are bulky in general, and thus are limited in portability. Further, because the circular nature of the tube, only the pressure at the entrance and exit may be measured, and thus measuring only apparent viscosity unless two capillary tubes are used with different ratio of length to diameter, rendering them even bulkier. As such, capillary tube viscometers are generally targeted at the investigation of Newtonian fluids, and thus other benchtop instruments have been developed to investigate the viscosity of non-Newtonian fluids. For example, rotational cone and plate viscometers (also known as rheometers) can be used for the investigation of non-Newtonian fluids by measuring the torque required to rotate a cone in contact with the fluid of interest. Providing a more detailed investigation of fluids at different shear rates, the rheometers have become popular instruments for viscosity measurement. However, rheometers require a large number of samples for measuring true viscosity and also suffers from limited portability. Thus, these benchtop instruments exhibit limitations in terms of throughput and sample volume required (hundreds of microliters to milliliter volumes), as well as their inability to measure the viscosity at the point of sample collection which limits their use only to settings where such instruments are available.

More recently, microfluidic approaches have gained interest for their application of measurement of viscosity. See U.S. Pub. Pat. App. No. 20210387193A1 (Solomon et al.); U.S. Pat. No. 7,290,441B2 (Baek et al.); Han, et al., A PDMS Viscometer for Microliter Newtonian Fluid, Journal of micromechanics and Microengineering (2007); and International App. Pub. No. WO2006/036833A2 (Burns et al.). For example, Solomon et al uses a pumping system to flow the fluid of interest at a defined flow rate and measures the pressure difference across a microfluidic channel to determine viscosity. While reducing the sample volume required in comparison to non-microfluidic approaches, this approach is limited in terms of throughput and user operation. In another example, Burns et al. has developed a microfluidic approach which is compatible with both Newtonian and non-Newtonian fluids using low sample volume, but uses fluid-driven flow by capillary pressure generated in a microfluidic channel to investigate the viscosity through comparison of a sample and a reference fluid. In yet another example, Han et al. have developed a microfluidic approach using gas solubility of a polydimethylsiloxane (PDMS) for measurement of a sample viscosity through a comparison with a reference fluid of a known viscosity. However, this approach remains limited in terms of portability and throughput due to a requirement to use a bench-top workstation and a control channel for commencing viscosity measurement.

Consequently, there is a need for an improved apparatus and method that is cost-effective and portable with analytical capabilities for viscosity measurement using low sample volumes, e.g., microliter.

### SUMMARY OF THE INVENTION

These needs, and others, are met by a microfluidic viscometer that comprises a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and one or more fluids of interest with unknown viscosity, and an imaging device configured to automatically and continuously acquire images of fluid flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure the viscosity of the one or more fluids of interest based at least in part on the analyzed and compared viscosity parameters.

Optionally, in any embodiment of the microfluidic viscometer according to the disclosed concept, the microfluidic viscometer has undergone vacuum treatment, and upon exposing the microfluidic device to an ambient air, diffusion of gas molecules in the ambient air into PDMS walls of the microfluidic channels generates a negative pressure that drives the flows of the plurality of fluids through the channels.

Optionally, in any embodiment of the microfluidic viscometer according to the disclosed concept, the viscosity measurement analyzer comprises a reference fluid selector configured to select a reference fluid from the plurality of fluids; and a viscosity calculator configured to calculate the viscosity parameters of the plurality of fluids upon introduction of last fluid of the plurality of fluids and measure the viscosity of the one or more fluids of interest based at least in part on the viscosity parameters.

Optionally, in any embodiment of the microfluidic viscometer according to the disclosed concept, the viscosity parameters comprise at least one of flow rates Q of the plurality of fluids, distances L travelled by the plurality of fluids, and a ratio

$$\frac{{η}_{sample}}{{η}_{ref}}$$

of the viscosity ηₛₐₘₚₗₑ of each fluid of interest to a viscosity η_{ref} of the reference fluid, where the flow rates

$$Q = \frac{Δ P}{{R}_{H}} = Δ P \frac{{A}^{2}}{η {LC}_{geom}} , the ratio \frac{{η}_{sample}}{{η}_{ref}} = \frac{{Q}_{ref} {L}_{ref}}{{Q}_{sample} {L}_{sample}} ,$$

ΔP is pressure drop between the one end and the distal end, R_{H} is hydraulic resistance to flow, A is area of the cross section of each microfluidic channel, C_{geom} is the constant related to channel geometry, η is the viscosity of a fluid, η_{ref} is the viscosity of the reference fluid, ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest.

Optionally, in any embodiment of the microfluidic viscometer according to the disclosed concept, the one or more fluids of interest comprise a single fluid of interest, the reference fluid selector selects the fluid of known viscosity as the reference fluid and the viscosity calculator simultaneously calculates the viscosity parameters of the plurality of fluids, analyzes and compares calculated viscosity parameters, and measures the viscosity of the single fluid of interest based at least in part on the analyzed and compared viscosity parameters.

Optionally, in any embodiment of the microfluidic viscometer according to the disclosed concept, the viscosity measurement analyzer comprises a parameter plotter configured to plot the flow rate Q_{ref} multiplied by the distance L_{ref} of the reference fluid with respect to the flow rate Qₛₐₘₚₗₑ multiplied by the distance Lₛₐₘₚₗₑ of the single fluid of interest, and a data fitter configured to fit data including the viscosity parameters and the plotted viscosity parameters over a plurality of points in time, and wherein the viscosity calculator measures the viscosity of the single fluid of interest based at least in part on the data fitted by the data fitter.

Optionally, in any embodiment of the microfluidic viscometer according to the disclosed concept, the viscosity measurement analyzer further comprises a Newtonian behavior detector that is configured to verify Newtonian behavior of the single fluid of interest based on the data fitted over the plurality of points in time, and wherein the viscosity calculator calculates the viscosity of the single fluid of interest based at least in part on the fitted data and the verification of Newtonian behavior of the single fluid of interest.

Optionally, in any embodiment of the microfluidic viscometer according to the disclosed concept, the one or more fluids of interest comprise a plurality of fluids of interest, the reference fluid selector selects the at least one fluid with known viscosity as the reference fluid, and the viscosity calculator simultaneously calculates the viscosity parameters of the plurality of fluids and measures viscosities of the plurality of fluids of interest using the viscosity η_{ref} of the reference fluid and viscosity ratios

$$\frac{{η}_{sample}}{{η}_{ref}}$$

between the viscosities ηₛₐₘₚₗₑ of the plurality of fluids of interest and the viscosity n_{ref} of the reference fluid.

Optionally, in any embodiment of the microfluidic viscometer according to the disclosed concept, the viscosity measurement analyzer determines that the plurality of fluids of interest comprises a first fluid of interest whose viscosity measurement is complete using the viscosity of the reference fluid and the viscosity ratios between the viscosities of the plurality of fluids of interest and the viscosity of the reference fluid, and a second fluid of interest whose viscosity measurement is not yet complete. The reference fluid selector selects the first fluid of interest as a new reference fluid, and the viscosity calculator simultaneously calculates the viscosity parameters of the plurality of fluids of interest and measures viscosity of the second fluid of interest using the viscosity η_{ref} of the new reference fluid and viscosity ratios

$$\frac{{η}_{sample}}{{η}_{ref}}$$

sample between the viscosities ηₛₐₘₚₗₑ of the plurality of fluids of interest and the viscosity η_{ref} of the new reference fluid.

Optionally, in any embodiment of the microfluidic viscometer according to the disclosed concept, the viscosity measurement analyzer determines that the second fluid of interest comprises a third fluid of interest whose viscosity measurement is complete using the viscosity of the new reference fluid and the viscosity ratios between the viscosities of the plurality of fluids and the viscosity of the new reference fluid, and remaining fluid of interest whose viscosity measurement is not yet complete. The reference fluid selector selects the third fluid of interest as the new reference fluid. The viscosity calculator calculates viscosity parameters of the second fluid of interest and measures viscosity of the remaining fluid of interest using the viscosity η_{ref} of the new reference fluid and viscosity ratios

$$\frac{{η}_{sample}}{{η}_{ref}}$$

between the viscosity ηₛₐₘₚₗₑ of the remaining fluid of interest and the viscosity η_{ref} of the new reference fluid.

Optionally, in any embodiment of the microfluidic viscometer according to the disclosed concept, the viscosity measurement analyzer further comprises a matrix generator configured to generate a matrix of the viscosity measurements of the plurality of fluids of interest and perform correlation of the viscosity measurements, an error detector configured to detect an error in the viscosity measurements, and an error corrector configured to correct the error. The matrix generator generates a matrix of the viscosity measurements of the plurality of fluids of interest and determines if the viscosities of the remaining fluid of interest measured using the first fluid of interest and the third fluid of interest as the new reference fluid correlate. Based on a determination that the viscosities of the remaining fluid of interest measured using the first fluid of interest and the third fluid of interest as the new reference fluid do not correlate, the viscosity measurement analyzer performs an error correction.

Optionally, in any embodiment of the microfluidic viscometer according to the disclosed concept, for the error correction, the error detector detects a viscosity measurement of the remaining fluid of interest that does not correlate with other viscosity measurements of the remaining fluid of interest, and determines that the other viscosity measurements of the remaining fluid of interest are equal. The error corrector excludes the viscosity measurement that does not correlate with the other viscosity measurements of the remaining fluid of interest. The viscosity calculator measures the viscosity of the remaining fluid of interest using at least one of the new reference fluid and an average of the other viscosity measurements of the remaining fluid of interest.

Optionally, in any embodiment of the microfluidic viscometer according to the disclosed concept, the viscosity measurement analyzer determines if the remaining fluid of interest comprises a further remaining fluid of interest whose viscosity measurement is not yet complete. Based on a determination that the remaining fluid of interest does not comprise the further remaining fluid of interest, the viscosity measurement analyzer determines that viscosity measurements of all of the fluids of interest have been successful and complete. Alternatively, wherein based on a determination that the remaining fluid of interest comprises the further remaining fluid of interest, the viscosity calculator measures viscosity of the further remaining fluid of interest and/or performs the error correction until the viscosity measurements of all of the further remaining fluid of interest is complete.

Optionally, in any embodiment of the microfluidic viscometer according to the disclosed concept, the viscosity measurement analyzer further comprises a matrix generator configured to generate a matrix of viscosity measurements of the plurality of fluids of interest and perform correlation of the viscosity measurements, and the high viscosity detector configured to determine if the plurality of fluids of interest comprises a first fluid of interest having a viscosity within a measurable viscosity range of the reference fluid and a second fluid of interest having a viscosity beyond the measurable viscosity range of the reference fluid.

Optionally, in any embodiment of the microfluidic viscometer according to the disclosed concept, the high viscosity detector determines that the plurality of fluids comprises the first fluid of interest and the second fluid of interest. Based on the determination that the plurality of fluids of interest comprises the first fluid and the second fluid, the reference fluid selector selects the first fluid of interest as a new reference fluid. And the viscosity calculator calculates the viscosity parameters including at least flow rates Q of the second fluid of interest and the new reference fluid, distances L travelled by the second fluid of interest and the new reference fluid, and a viscosity ratio

$$\frac{{η}_{sample}}{{η}_{ref}}$$

between the viscosity ηₛₐₘₚₗₑ of the second fluid of interest and the viscosity η_{ref} of the new reference fluid, and measures the viscosity of the second fluid of interest.

Optionally, in any embodiment of the microfluidic viscometer according to the disclosed concept, the viscosity measurement analyzer determines if the second fluid of interest comprises a third fluid of interest whose viscosity measurement is complete using the new reference fluid and remaining fluid of interest whose viscosity measurement could not be made using the new reference fluid. Based on a determination that the second fluid of interest does not comprise the third fluid of interest and the remaining fluid of interest, the viscosity measurement analyzer determines that the viscosity measurements of all of the plurality of the fluids of interest have been successful and complete. Alternatively, based on a determination that the second fluid of interest comprises the third fluid of interest and the remaining fluid of interest, the reference fluid selector selects the third fluid of interest as the new reference fluid. Upon the selection of the third fluid of interest as the new reference, the viscosity calculator measures the viscosity of the remaining fluid of interest using the new reference fluid. Upon the measurement of the viscosity of the remaining fluid of interest using the new reference fluid, the matrix generator determines if the viscosities of the remaining fluid of interest measured using the first fluid of interest and the second fluid of interest as the new reference fluid correlate. Based on a determination that the viscosities of the remaining fluid of interest measured using the first fluid of interest and the second fluid of interest as the new reference fluid correlate, the viscosity measurement analyzer determines that the viscosity measurement of the remaining fluid of interest has been successful based at least in part on the correlation

Optionally, in any embodiment of the microfluidic viscometer according to the disclosed concept, the viscosity measurement analyzer determines if the remaining fluid of interest comprises a further remaining fluid of interest whose viscosity is beyond the measurable range of the reference fluid. Based on a determination that the remaining fluid of interest does not comprise the further remaining fluid of interest, the viscosity measurement analyzer determines that the viscosity measurements of all of the remaining fluids of interest have been successful and complete. Alternatively, based on a determination that the remaining fluid of interest comprises the further remaining fluid of interest, the viscosity measurement analyzer measures the viscosity of the further remaining fluid of interest until the viscosity measurement of all of the further remaining fluid of interest has been complete and successful.

Optionally, in any embodiment of the microfluidic viscometer according to the disclosed concept, the at least one fluid with known viscosity comprises a plurality of fluids of known viscosities, and the viscosities of the one or more fluids of interest are measured using the known viscosities.

Optionally, in any embodiment of the microfluidic viscometer according to the disclosed concept, the viscosity measurement analyzer further comprises a non-Newtonian behavior detector configured to detect non-Newtonian behavior of a non-Newtonian fluid of interest based at least in part on flow rates Q as developed for Newtonian fluids and estimate parameters including a power-law exponent of the non-Newtonian fluid of interest.

Optionally, in any embodiment of the microfluidic viscometer according to the disclosed concept, the viscosity calculator measures viscosity of the non-Newtonian fluid of interest based at least in part on the estimated parameters of the non-Newtonian fluid of interest.

Optionally, in any embodiment of the microfluidic viscometer according to the disclosed concept, the viscosity measurement analyzer further comprises an imaging manager that comprises at least one of an image aligner configured to automatically detect and align positions of the microfluidic channels independently of the position of the microfluidic device in the fields of view of the imaging device, a background corrector configured to reduce an influence of a background from the images of the fluid flows, a thresholding element configured to replace values corresponding to the background with black pixels for image segmentation, and a filtering element configured to filter out background and noises from the acquired images of the fluid flows.

Optionally, in any embodiment of the microfluidic viscometer according to the disclosed concept, the microfluidic device is vacuum packaged in a package and configured to be removed from the package at fluids collection.

Optionally, in any embodiment of the microfluidic viscometer according to the disclosed concept, each microfluidic channel is rectangular in shape and has a height of 50 μm, a width of 400 μm, and a length of 8 cm.

Optionally, in any embodiment of the microfluidic viscometer according to the disclosed concept, an amount of fluid introduced in each inlet is approximately 5 μL.

Optionally, in any embodiment of the microfluidic viscometer according to the disclosed concept, pressure driving the plurality of fluids in the microfluidic channels is equally distributed within each microfluidic channel.

Optionally, in any embodiment of the microfluidic viscometer according to the disclosed concept, the imaging device comprises a camera integrated in a mobile device.

Optionally, in any embodiment of the microfluidic viscometer according to the disclosed concept, the mobile device comprises a smartphone, a tablet, or a laptop computer.

Optionally, in any embodiment of the microfluidic viscometer according to the disclosed concept, the microfluidic viscometer completes the acquisition of the images, calculation of viscosity parameters, analysis and comparison of the viscosity parameters and viscosity measurements of the one or more fluids of interest in less than five minutes.

Optionally, in any embodiment of the microfluidic viscometer according to the disclosed concept, the imaging device has a frame rate of at least 50 frames per second.

Optionally, in any embodiment of the microfluidic viscometer according to the disclosed concept, the imaging device provides at least 1,000 images per viscosity measurement, the viscosity measurement including at least acquisition of the images, calculation of the viscosity parameters based at least in part on the acquired images, analysis and comparison of the viscosity parameters, and viscosity measurements of the viscosity of the one or more fluids of interest.

Optionally, in any embodiment of the microfluidic viscometer according to the disclosed concept, the microfluidic device does not include any layer disposed on top of the PDMS layer.

Optionally, in any embodiment of the microfluidic viscometer according to the disclosed concept, the microfluidic device does not include a control channel structured to assess start of the viscosity measurement of the plurality of fluids.

Optionally, in any embodiment of the microfluidic viscometer according to the disclosed concept, the microfluidic device is a single use device.

In an optional aspect of the disclosed concept, a method of measuring viscosities of a plurality of fluids includes providing a microfluidic viscometer that comprises (i) a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and one or more fluids of interest with unknown viscosity, and (ii) an imaging device configured to automatically and continuously acquire images of flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure viscosities of the one or more fluids of interest based at least in part on the analyzed and compared viscosity parameters. The method also includes acquiring, by the imaging device, images of the flows of the plurality of fluids within the microfluidic channels, and measuring, by the viscosity measurement analyzer, the viscosities of the one or more fluids of interest based at least in part on the acquired images.

Optionally, in any embodiment of the method according to the disclosed concept, the one or more fluids of interest comprise a single fluid of interest, and the measuring, by the viscosity measurement analyzer, the viscosity of the fluid of interest comprises selecting, by a reference fluid selector of the viscosity measurement analyzer, the fluid of known viscosity as a reference fluid, calculating simultaneously, by a viscosity calculator of the viscosity measurement analyzer, the viscosity parameters including at least flow rates Q of the plurality of fluids, distances L travelled by the plurality of fluids, and a viscosity ratio

$$\frac{{η}_{sample}}{{η}_{ref}}$$

between the viscosity ηₛₐₘₚₗₑ of the single fluid of interest and the viscosity η_{ref} of the reference fluid, where the flow rates

$$Q = \frac{Δ P}{{R}_{H}} = Δ P \frac{{A}^{2}}{η {LC}_{g e o m}} ,$$

the viscosity ratio

$$\frac{{η}_{sample}}{{η}_{ref}} = \frac{{Q}_{ref} {L}_{ref}}{{Q}_{sample} {L}_{sample}} ,$$

ΔP is the pressure drop between the one end and the distal end, R_{H} is hydraulic resistance to flow, A is the area of the cross section of each microfluidic channel, and C_{geom} is a constant related to channel geometry and ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest, analyzing and comparing calculated viscosity parameters, and measuring, by the viscosity calculator, the viscosity of the single fluid of interest based at least in part on the analyzed and compared viscosity parameters.

Optionally, in any embodiment of the method according to the disclosed concept, the measuring, by the viscosity measurement analyzer, the viscosities of the one or more fluids of interest based at least in part on the acquired images further comprises plotting the flow rate Q_{ref} multiplied by the distance L_{ref} of the reference fluid with respect to the flow rate Qₛₐₘₚₗₑ multiplied by the distance Lₛₐₘₚₗₑ of the single fluid of interest, fitting data including the plotted viscosity parameters over a plurality of points in time, and measuring, by the viscosity calculator, the viscosity of the single fluid of interest based at least in part on the fitted data.

Optionally, in any embodiment of the method according to the disclosed concept, the measuring, by the viscosity measurement analyzer, the viscosities of the one or more fluids of interest based at least in part on the acquired images further comprises verifying Newtonian behavior of the single second fluid based on the fitted data.

Optionally, in any embodiment of the method according to the disclosed concept, the one or more fluids of interest comprise a plurality of fluids of interest and the measuring, by the viscosity measurement analyzer, the viscosities of the one or more fluids of interest based at least in part on the acquired images comprises selecting, by a reference fluid selector of the viscosity measurement analyzer, the at least one fluid with known viscosity as the reference fluid, calculating simultaneously, by a viscosity calculator of the viscosity measurement analyzer, the viscosity parameters of the plurality of fluids including at least flow rates Q of the plurality of fluids, distances L travelled by the plurality of fluids, and viscosity ratios

$$\frac{{η}_{sample}}{{η}_{ref}}$$

between the viscosities ηₛₐₘₚₗₑ of the plurality of fluids of interest and the viscosity η_{ref} of the reference fluid, where the flow rates

$$Q = \frac{Δ P}{{R}_{H}} = Δ P \frac{{A}^{2}}{η {LC}_{geom}} ,$$

the viscosity ratio

$$\frac{{η}_{sample}}{{η}_{ref}} = \frac{{Q}_{ref} {L}_{ref}}{{Q}_{sample} {L}_{sample}} ,$$

ΔP is the pressure drop between the one end and the distal end, R_{H} is hydraulic resistance to flow, A is the area of the cross section of each microfluidic channel, and C_{geom} is a constant related to channel geometry and ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest, and measuring, by the viscosity calculator, the viscosities of the plurality of fluids of interest using the viscosity η_{ref} of the reference fluid and viscosity ratios

$$\frac{{η}_{sample}}{{η}_{ref}}$$

between the viscosities ηₛₐₘₚₗₑ of the plurality of fluids of interest and the viscosity η_{ref} of the reference fluid.

Optionally, in any embodiment of the method according to the disclosed concept, the measuring, by the viscosity measurement analyzer, the viscosities of the one or more fluids of interest based at least in part on the acquired images further comprises determining, by the viscosity measurement analyzer, that the plurality of fluids of interest comprises a first fluid of interest whose viscosity measurement is complete using the viscosity of the reference fluid and the viscosity ratios between the viscosities of the plurality of fluids of interest and the viscosity of the reference fluid, and a second fluid of interest whose viscosity measurement is not yet complete, selecting, by the reference fluid selector, the first fluid of interest as a new reference fluid, calculating simultaneously, by the viscosity calculator, the viscosity parameters of the plurality of fluids of interest, and measuring, by the viscosity calculator, the viscosity of the second fluid of interest using the viscosity η_{ref} of the new reference fluid and viscosity ratios

$$\frac{{η}_{sample}}{{η}_{ref}}$$

between the viscosities ηₛₐₘₚₗₑ of the plurality of fluids of interest and the viscosity η_{ref} of the new reference fluid.

Optionally, in any embodiment of the method according to the disclosed concept, the measuring, by the viscosity measurement analyzer, the viscosities of the one or more fluids of interest based at least in part on the acquired images further comprises determining, by the viscosity measurement analyzer, that the second fluid of interest comprises a third fluid of interest whose viscosity measurement is complete using the viscosity of the new reference fluid and the viscosity ratios between the viscosities of the plurality of fluids and the viscosity of the new reference fluid, and remaining fluid of interest whose viscosity measurement is not yet complete, selecting, by the reference fluid selector, the third fluid of interest as the new reference fluid, calculating simultaneously, by the viscosity calculator, the viscosity parameters of the second fluid of interest, and measuring, by the viscosity of the remaining fluid of interest using the viscosity η_{ref} of the new reference fluid and viscosity ratios

$$\frac{{η}_{sample}}{{η}_{ref}}$$

between the viscosity ηₛₐₘₚₗₑ of the remaining fluid of interest and the viscosity η_{ref} of the third reference fluid.

Optionally, in any embodiment of the method according to the disclosed concept, the measuring, by the viscosity measurement analyzer, the viscosities of the one or more fluids of interest based at least in part on the acquired images further comprises, generating, by a matrix generator of the viscosity measurement analyzer, a matrix of the viscosity measurements of the plurality of fluids of interest, determining, by the matrix generator, if the viscosities of the remaining fluid of interest measured using the first fluid of interest and the third fluid of interest as the new reference fluid correlate, and based on a determination that the viscosities of the remaining fluid of interest measured using the first fluid of interest and the third fluid of interest as the new reference fluid do not correlate, performing by the viscosity measurement analyzer an error correction.

Optionally, in any embodiment of the method according to the disclosed concept, the error correction comprises detecting, by the error detector of the viscosity measurement analyzer, a viscosity measurement of the remaining fluid of interest that does not correlate with other viscosity measurements of the remaining fluid of interest, determining, by the error detector; that the other viscosity measurements of the remaining fluid of interest are equal, excluding, by an error corrector of the viscosity measurement analyzer, the viscosity measurement that does not correlate with the other viscosity measurements of the remaining fluid of interest, and measuring, by the viscosity calculator, the viscosity of the remaining fluid of interest using at least one of the new reference fluid and an average of the other viscosity measurements of the remaining fluid of interest.

Optionally, in any embodiment of the method according to the disclosed concept, the measuring, by the viscosity measurement analyzer, the viscosities of the one or more fluids of interest based at least in part on the acquired images further comprises determining, by the viscosity measurement analyzer, if the remaining fluid of interest comprises a further remaining fluid of interest whose viscosity measurement is not yet complete, based on a determination that the remaining fluid of interest does not comprise the further remaining fluid of interest, determining by the viscosity measurement analyzer that viscosity measurements of all of the fluids of interest have been successful and complete, or based on a determination that the remaining fluid of interest comprises the further remaining fluid of interest, measuring by the viscosity calculator, viscosity of the further fluid of interest and/or performing, by the viscosity measurement analyzer, the error correction until the viscosity measurements of all of the further remaining fluid of interest is complete.

Optionally, in any embodiment of the method according to the disclosed concept, the measuring, by the viscosity measurement analyzer, the viscosity of the fluid of interest based at least in part on the acquired images further comprises determining by, a high viscosity detector of the viscosity measurement analyzer, if the plurality of fluids of interest comprises a first fluid of interest having a viscosity within a measurable viscosity range using the viscosity of the reference fluid and a second fluid of interest having a viscosity beyond the measurable viscosity range using the viscosity of the reference fluid, based on a determination that the plurality of fluids of interest comprises the first fluid and the second fluid, selecting by the reference fluid selector the first fluid of interest as a new reference fluid, calculating, by the viscosity calculator, the viscosity parameters including at least flow rates Q of the second fluid of interest and the new reference fluid, distances L travelled by the second fluid of interest and the new reference fluid, and a viscosity ratio

$$\frac{{η}_{sample}}{{η}_{ref}}$$

between the viscosity ηₛₐₘₚₗₑ of the second fluid of interest and the viscosity η_{ref} of the new reference fluid, and measuring by the viscosity calculator the viscosity of the second fluid of interest.

Optionally, in any embodiment of the method according to the disclosed concept, the measuring, by the viscosity measurement analyzer, the viscosity of the fluid of interest based at least in part on the acquired images further comprises determining by the viscosity measurement analyzer if the second fluid of interest comprises a third fluid of interest whose viscosity measurement is complete using the new reference fluid and remaining fluid of interest whose viscosity measurement could not be made using the new reference fluid; and based on a determination that the second fluid of interest does not comprise the third fluid of interest and the remaining fluid of interest, determining by the viscosity measurement analyzer that the viscosity measurements of all of the plurality of the fluids of interest have been successful and complete, or based on a determination that the second fluid of interest comprises the third fluid of interest and the remaining fluid of interest, selecting by the reference fluid selector the third fluid of interest as the new reference fluid, upon the selection of the third fluid of interest as the new reference, measuring by the viscosity calculator the viscosity of the remaining fluid of interest using the new reference fluid, upon the measurement of the viscosity of the remaining fluid of interest using the new reference fluid, determining by the matrix generator if the viscosities of the remaining fluid of interest measured using the first fluid of interest and the second fluid of interest as the new reference fluid correlate, and based on a determination that the viscosities of the remaining fluid of interest measured using the first fluid of interest and the second fluid of interest as the new reference fluid correlate, determining by the viscosity measurement analyzer that the viscosity measurement of the remaining fluid of interest has been successful based at least in part on the correlation.

Optionally, in any embodiment of the method according to the disclosed concept, the measuring, by the viscosity measurement analyzer, the viscosities of the one or more fluids of interest based at least in part on the acquired images further comprises: determining, by the viscosity measurement analyzer, if the remaining fluid of interest comprises a further remaining fluid of interest whose viscosity measurement is not yet complete, and based on a determination that the remaining fluid of interest does not comprise the further remaining fluid of interest, determining by the viscosity measurement analyzer that viscosity measurements of all of the fluids of interest have been successful and complete, or based on a determination that the remaining fluid of interest comprises the further remaining fluid of interest, measuring by the viscosity calculator, viscosity of the further remaining fluid of interest until the viscosity measurements of all of the further remaining fluid of interest is complete.

Optionally, in any embodiment of the method according to the disclosed concept, the at least one fluid with known viscosity comprises a plurality of fluids of known viscosities, and the viscosities of the one or more fluids of interest are measured using the known viscosities.

Optionally, in any embodiment of the method according to the disclosed concept, the measuring, by the viscosity measurement analyzer, the viscosities of the one or more fluids of interest based at least in part on the acquired images further comprises detecting by a non-Newtonian behavior detector of the viscosity measurement analyzer, non-Newtonian behavior of a non-Newtonian fluid of interest based at least in part on flow rates Q as developed for Newtonian fluids; estimating, by the non-Newtonian behavior detector, parameters including a power-law exponent of the non-Newtonian fluid of interest; and measuring, by the viscosity calculator, viscosity of the non-Newtonian behavior detector based at least in part on the estimated parameters.

Optionally, in any embodiment of the method according to the disclosed concept, the method further comprises at least one of detecting and aligning, by an image aligner of the imaging device, positions of the microfluidic channels independently of the position of the microfluidic device in the fields of view of the imaging device; reducing, by a background corrector of the imaging device, an influence of a background from the images of the fluid flows; replacing, by a thresholding element of the imaging device, values corresponding to the background with black pixels; and filtering out, by a filtering element of the imaging device, background and noises from the images of the fluid flows.

Optionally, in any embodiment of the method according to the disclosed concept, the microfluidic viscometer has undergone vacuum treatment, and upon exposing the microfluidic device to an ambient air, diffusion of gas molecules in the ambient air into PDMS walls of the microfluidic channels generates a negative pressure that drives the flows of the plurality of fluids through the channels.

Optionally, in any embodiment of the method according to the disclosed concept, the microfluidic device is vacuum packaged in a package and configured to be removed from the package at fluids collection.

Optionally, in any embodiment of the method according to the disclosed concept, each microfluidic channel is rectangular in shape and has a height of 50 μm, a width of 400 μm, and a length of 8 cm.

Optionally, in any embodiment of the method according to the disclosed concept, an amount of fluid introduced in each inlet is approximately 5 μL.

Optionally, in any embodiment of the method according to the disclosed concept, pressure driving the plurality of fluids in the microfluidic channels is equally distributed within each microfluidic channel.

Optionally, in any embodiment of the method according to the disclosed concept, the imaging device comprises a camera integrated in a mobile device.

Optionally, in any embodiment of the method according to the disclosed concept, the mobile device comprises a smartphone, a tablet, or a laptop computer.

Optionally, in any embodiment of the method according to the disclosed concept, the microfluidic viscometer completes the acquisition of the images, calculation of viscosity parameters, analysis and comparison of the viscosity parameters and viscosity measurements of the one or more fluid sof interest in less than five minutes.

Optionally, in any embodiment of the method according to the disclosed concept, the imaging device has a frame rate of at least 50 frames per second.

Optionally, in any embodiment of the method according to the disclosed concept, the imaging device provides at least 1,000 images per viscosity measurement, the viscosity measurement including at least acquisition of the images, calculation of the viscosity parameters based at least in part on the acquired images, analysis and comparison of the viscosity parameters, and viscosity measurements of the one or more fluids of interest.

Optionally, in any embodiment of the method according to the disclosed concept, the microfluidic device does not include any layer disposed on top of the PDMS layer.

Optionally, in any embodiment of the method according to the disclosed concept, the microfluidic device does not include a control channel structured to assess start of the viscosity measurement of the plurality of fluids.

Optionally, in any embodiment of the method according to the disclosed concept, the microfluidic device is a single use device.

In an optional aspect of the disclosed concept, a method of measuring viscosities of a plurality of fluids is provided. The method comprises providing a microfluidic viscometer that comprises (i) a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and a plurality of fluids of interest with unknown viscosity, and (ii) an imaging device configured to automatically and continuously acquire images of flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure the viscosity of the plurality of fluids of interest based at least in part on the analyzed and compared viscosity parameters. The method further comprises introducing the plurality of fluids to the inlets of the microfluidic device introducing the plurality of fluids to the inlets of the microfluidic device; acquiring, by the imaging device, images of the flows of the plurality of fluids within the microfluidic channels; selecting, by a reference fluid selector of the viscosity measurement analyzer, the at least one fluid with known viscosity as a reference fluid; and calculating simultaneously, by a viscosity calculator of the viscosity measurement analyzer, the viscosity parameters including at least flow rates Q of the plurality of fluids, distances L travelled by the plurality of fluids, and viscosity ratios

$$\frac{{η}_{sample}}{{η}_{ref}}$$

between the viscosities ηₛₐₘₚₗₑ of the plurality of fluids of interest and the viscosity η_{ref} of the reference fluid, where the flow rates

$$Q = \frac{Δ P}{{R}_{H}} = Δ P \frac{{A}^{2}}{η {LC}_{geom}} ,$$

the viscosity ratio

$$\frac{{η}_{sample}}{{η}_{ref}} = \frac{{Q}_{ref} {L}_{ref}}{{Q}_{sample} {L}_{sample}} ,$$

ΔP is the pressure drop between the one end and the distal end, R_{H} is hydraulic resistance to flow, A is the area of the cross section of each microfluidic channel, and C_{geom} is a constant related to channel geometry and ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest; and measuring, by the viscosity calculator, the viscosities of the plurality of fluids of interest using the viscosity η_{ref} of the reference fluid and viscosity ratios

$$\frac{{η}_{sample}}{{η}_{ref}}$$

between the viscosities ηₛₐₘₚₗₑ of the plurality of fluids of interest and the viscosity η_{ref} of the reference fluid.

Optionally, in any embodiment of the method according to the disclosed concept, the measuring, by the viscosity calculator, the viscosities of the plurality of fluids of interest comprises determining, by the viscosity measurement analyzer, that the plurality of fluids of interest comprises a first fluid of interest whose viscosity measurement is complete using the viscosity of the reference fluid and the viscosity ratios between the viscosities of the plurality of fluids of interest and the viscosity of the reference fluid, and a second fluid of interest whose viscosity measurement is not yet complete; selecting, by the reference fluid selector, the first fluid of interest as a new reference fluid; calculating simultaneously, by the viscosity calculator, the viscosity parameters of the plurality of fluids of interest; and measuring, by the viscosity calculator, the viscosity of the second fluid of interest using the viscosity η_{ref} of the new reference fluid and viscosity ratios

$$\frac{{η}_{sample}}{{η}_{ref}}$$

between the viscosities ηₛₐₘₚₗₑ of the plurality of fluids of interest and the viscosity η_{ref} of the new reference fluid.

Optionally, in any embodiment of the method according to the disclosed concept, the measuring, by the viscosity calculator, the viscosities of the plurality of fluids of interest further comprises determining, by the viscosity measurement analyzer, that the second fluid of interest comprises a third fluid of interest whose viscosity measurement is complete using the viscosity of the new reference fluid and the viscosity ratios between the viscosities of the plurality of fluids and the viscosity of the new reference fluid, and remaining fluid of interest whose viscosity measurement is not yet complete; selecting, by the reference fluid selector, the third fluid of interest as the new reference fluid; calculating simultaneously, by the viscosity calculator, the viscosity parameters of the second fluid of interest; and measuring, by the viscosity calculator, the viscosity of the remaining fluid of interest using the viscosity η_{ref} of the new reference fluid and viscosity ratios

$$\frac{{η}_{sample}}{{η}_{ref}}$$

between the viscosity ηₛₐₘₚₗₑ of the remaining fluid of interest and the viscosity η_{ref} of the third reference fluid.

Optionally, in any embodiment of the method according to the disclosed concept, the measuring, by the viscosity calculator, the viscosities of the plurality of fluids of interest further comprises determining, by the viscosity measurement analyzer, if the remaining fluid of interest comprises another fluid of interest whose viscosity measurement is not yet complete, and based on a determination that the remaining fluid of interest does not comprise the another fluid of interest, determining by the viscosity measurement analyzer that viscosity measurements of all of the fluids of interest have been successful and complete, or based on a determination that the remaining fluid of interest comprises the another fluid of interest, measuring by the viscosity measurement analyzer viscosity of the another fluid of interest until the viscosity measurements of all of the remaining fluid of interest is complete.

In an optional aspect of the disclosed concept, a method of automatically correcting an error in viscosity measurements of a plurality of fluids of interest is provided. The method includes providing a microfluidic viscometer that comprises (i) a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and a plurality of fluids of interest with unknown viscosity, and (ii) an imaging device configured to automatically and continuously acquire images of flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure viscosities of the plurality of fluids of interest based at least in part on the analyzed and compared viscosity parameters. The method further includes introducing the plurality of fluids to the inlets of the microfluidic device; acquiring, by the imaging device, images of the flows of the plurality of fluids within the microfluidic channels; selecting, by a reference fluid selector of the viscosity measurement analyzer, the at least one fluid with known viscosity as a reference fluid; calculating simultaneously, by a viscosity calculator of the viscosity measurement analyzer, the viscosity parameters including at least flow rates Q of the plurality of fluids, distances L travelled by the plurality of fluids, and viscosity ratios

$$\frac{{η}_{sample}}{{η}_{ref}}$$

between the viscosities ηₛₐₘₚₗₑ of the plurality of

$$Q = \frac{Δ P}{{R}_{H}} = Δ P \frac{{A}^{2}}{η {LC}_{geom}} ,$$

the viscosity ratio

$$\frac{{η}_{sample}}{{η}_{ref}} = \frac{{Q}_{ref} {L}_{ref}}{{Q}_{sample} {L}_{sample}} ,$$

ΔP is the pressure drop between the one end and the distal end, R_{H} is hydraulic resistance to flow, A is the area of the cross section of each microfluidic channel, and C_{geom} is a constant related to channel geometry and ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest; measuring, by the viscosity calculator, the viscosities of the plurality of fluids of interest using the viscosity η_{ref} of the reference fluid and viscosity ratios

$$\frac{{η}_{sample}}{{η}_{ref}}$$

between the viscosities ηₛₐₘₚₗₑ of the plurality of fluids of interest and the viscosity η_{ref} of the reference fluid; and correcting an error in the measured viscosities of the plurality of fluids of interest.

Optionally, in any embodiment of the method according to the disclosed concept, the measuring, by the viscosity calculator, the viscosities of the plurality of fluids of interest comprises determining, by the viscosity measurement analyzer, that the plurality of fluids of interest comprises a first fluid of interest whose viscosity measurement is complete using the viscosity of the reference fluid and the viscosity ratios between the viscosities of the plurality of fluids of interest and the viscosity of the reference fluid, and a second fluid of interest whose viscosity measurement is not yet complete; selecting, by the reference fluid selector, the first fluid of interest as a new reference fluid; calculating simultaneously, by the viscosity calculator, the viscosity parameters of the plurality of fluids of interest; and measuring, by the viscosity calculator, the viscosity of the second fluid of interest using the viscosity η_{ref} of the new reference fluid and viscosity ratios

$$\frac{{η}_{sample}}{{η}_{ref}}$$

between the viscosities ηₛₐₘₚₗₑ of the plurality of fluids of interest and the viscosity η_{ref} of the new reference fluid.

Optionally, in any embodiment of the method according to the disclosed concept, the measuring, by the viscosity measurement analyzer, the viscosity of the fluid of interest based at least in part on the acquired images further comprises generating, by a matrix generator of the viscosity measurement analyzer, a matrix of the viscosity measurements of the plurality of fluids of interest; determining, by the matrix generator, if the viscosities of the remaining fluid of interest measured using the first fluid of interest and the third fluid of interest as the new reference fluid correlate; and based on a determination that the viscosities of the remaining fluid of interest measured using the first fluid of interest and the third fluid of interest as the new reference fluid do not correlate, performing by the viscosity measurement analyzer an error correction.

Optionally, in any embodiment of the method according to the disclosed concept, the error correction comprises. detecting, by the error detector of the viscosity measurement analyzer, a viscosity measurement of the remaining fluid of interest that does not correlate with other viscosity measurements of the remaining fluid of interest; determining, by the error detector; that the other viscosity measurements of the remaining fluid of interest are equal; excluding, by an error corrector of the viscosity measurement analyzer, the viscosity measurement that does not correlate with the other viscosity measurements of the remaining fluid of interest; and measuring, by the viscosity calculator, the viscosity of the remaining fluid of interest using at least one of the new reference fluid and an average of the other viscosity measurements of the remaining fluid of interest

Optionally, in any embodiment of the method according to the disclosed concept, the measuring, by the viscosity measurement analyzer, the viscosity of the fluid of interest based at least in part on the acquired images further comprises determining, by the viscosity measurement analyzer, if the remaining fluid of interest comprises a further remaining fluid of interest whose viscosity measurement is not yet complete, and based on a determination that the remaining fluid of interest does not comprise the further remaining fluid of interest, determining by the viscosity measurement analyzer that viscosity measurements of all of the fluids of interest have been successful and complete, or based on a determination that the remaining fluid of interest comprises the further remaining fluid of interest, measuring by the viscosity calculator, viscosity of the further remaining fluid of interest and/or performing, by the viscosity measurement analyzer, the error correction until the viscosity measurements of all of the further remaining fluid of interest is complete.

In an optional aspect of the disclosed concept, a method of measuring a plurality of fluids of interest including a plurality of fluids of interest having a high viscosity is provided. The method includes providing a microfluidic viscometer that comprises (i) a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and a plurality of fluids of interest with unknown viscosity, and (ii) an imaging device configured to automatically and continuously acquire images of flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure viscosities of the plurality of fluids of interest based at least in part on the analyzed and compared viscosity parameters. The method further includes introducing the plurality of fluids to the inlets of the microfluidic device; acquiring, by the imaging device, images of the flows of the plurality of fluids within the microfluidic channels; selecting, by a reference fluid selector of the viscosity measurement analyzer, the at least one fluid with known viscosity as a reference fluid; calculating simultaneously, by a viscosity calculator of the viscosity measurement analyzer, the viscosity parameters including at least flow rates Q of the plurality of fluids, distances L travelled by the plurality of fluids, and viscosity ratios

$$\frac{{η}_{sample}}{{η}_{ref}}$$

between the viscosities ηₛₐₘₚₗₑ of the plurality of fluids of interest and the viscosity η_{ref} of the reference fluid, where the flow rates

$$Q = \frac{Δ P}{{R}_{H}} = Δ P \frac{{A}^{2}}{η {LC}_{geom}} ,$$

the viscosity ratio

$$\frac{{η}_{sample}}{{η}_{ref}} = \frac{{Q}_{ref} {L}_{ref}}{{Q}_{sample} {L}_{sample}} ,$$

ΔP is the pressure drop between the one end and the distal end, R_{H} is hydraulic resistance to flow, A is the area of the cross section of each microfluidic channel, and C_{geom} is a constant related to channel geometry and ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest; measuring, by the viscosity calculator, the viscosities of the plurality of fluids of interest using the viscosity η_{ref} of the reference fluid and viscosity ratios

$$\frac{{η}_{sample}}{{η}_{ref}}$$

between the viscosities ηₛₐₘₚₗₑ of the plurality of fluids of interest and the viscosity η_{ref} of the reference fluid; and determining by, a high viscosity detector of the viscosity measurement analyzer, if the plurality of fluids of interest comprises a first fluid of interest having a viscosity within a measurable viscosity range of the reference fluid and a second fluid of interest having a viscosity beyond the measurable viscosity range of the reference fluid.

Optionally, in any embodiment of the method according to the disclosed concept, the measuring, by the viscosity calculator, the viscosities of the plurality of fluids of interest comprises based on a determination that the plurality of fluids of interest comprises the first fluid and the second fluid, selecting by the reference fluid selector the first fluid of interest as a new reference fluid; calculating, by the viscosity calculator, the viscosity parameters including at least flow rates Q of the second fluid of interest and the new reference fluid, distances L travelled by the second fluid of interest and the new reference fluid, and a viscosity ratio

$$\frac{{η}_{sample}}{{η}_{ref}}$$

between the viscosity ηₛₐₘₚₗₑ of the second fluid of interest and the viscosity η_{ref} of the new reference fluid; and measuring by the viscosity calculator the viscosity of the second fluid of interest.

Optionally, in any embodiment of the method according to the disclosed concept, the measuring, by the viscosity calculator, the viscosities of the plurality of fluids of interest comprises determining by the viscosity measurement analyzer if the second fluid of interest comprises a third fluid of interest whose viscosity measurement is complete using the new reference fluid and remaining fluid of interest whose viscosity measurement could not be made using the new reference fluid; and based on a determination that the second fluid of interest does not comprise the third fluid of interest and the remaining fluid of interest, determining by the viscosity measurement analyzer that the viscosity measurements of all of the plurality of the fluids of interest have been successful and complete, or based on a determination that the second fluid of interest comprises the third fluid of interest and the remaining fluid of interest, selecting by the reference fluid selector the third fluid of interest as the new reference fluid, upon the selection of the third fluid of interest as the new reference, measuring by the viscosity calculator the viscosity of the remaining fluid of interest using the new reference fluid, upon the measurement of the viscosity of the remaining fluid of interest using the new reference fluid, determining by the matrix generator if the viscosities of the remaining fluid of interest measured using the first fluid of interest and the second fluid of interest as the new reference fluid correlate, and based on a determination that the viscosities of the remaining fluid of interest measured using the first fluid of interest and the second fluid of interest as the new reference fluid correlate, determining by the viscosity measurement analyzer that the viscosity measurement of the remaining fluid of interest has been successful based at least in part on the correlation.

Optionally, in any embodiment of the method according to the disclosed concept, the measuring, by the viscosity measurement analyzer, the viscosities of the plurality of fluids of interest further comprises determining, by the viscosity measurement analyzer, if the remaining fluid of interest comprises a further remaining fluid of interest whose viscosity measurement is not yet complete, and based on a determination that the remaining fluid of interest does not comprise the further remaining fluid of interest, determining by the viscosity measurement analyzer that viscosity measurements of all of the fluids of interest have been successful and complete, or based on a determination that the remaining fluid of interest comprises the further remaining fluid of interest, measuring by the viscosity calculator, viscosity of the further remaining fluid of interest until the viscosity measurements of all of the further remaining fluid of interest is complete.

### BRIEF DESCRIPTION OF THE DRAWINGS

A full understanding of the invention can be gained from the following description of the preferred embodiments when read in conjunction with the accompanying drawings in which:

FIG. 1 is a top view of a system for measuring viscosities of a plurality of fluids using an exemplary microfluidic viscometer configured to measure viscosity of a plurality of fluids at sample collection. The microfluidic viscometer includes a microfluidic device that has a plurality of microfluidic channels and is vacuum packaged prior to its use and an imaging device that includes a viscosity measurement analyzer for automated viscosity measurement and analysis of one or more fluids of interests at a point of sample collection in accordance with an optional aspect of the disclosed concept;

FIG. 2A is an enlarged top view of the microfluidic device having the plurality of microfluidic channels of FIG. 1;

FIG. 2B is an enlarged perspective view of a portion of a microfluidic channel within an area B of the microfluidic device of FIG. 2A;

FIG. 2C is a front view of the cross-section of the microfluidic channel of FIG. 2A cut through line A-A as shown in FIG. 2B;

FIG. 2D is an enlarged top view of one of the microfluidic channels of the microfluidic device of FIG. 2A;

FIG. 3A is a perspective top view of the microfluidic device of FIG. 2 in the process of filling an inlet of one of the microfluidic channels with a fluid;

FIG. 3B is a perspective top view of the microfluidic device of FIG. 2 with its inlets having been filled with a plurality of fluid;

FIG. 4 is a top view of the microfluidic viscometer of FIG. 1 with the imaging device capturing an image of the plurality of fluids flowing within the microfluidic channels of the microfluidic device in accordance with an optional aspect of the disclosed concept;

FIG. 5 is an exemplary image of the plurality of fluids flowing in the microfluidic channels of the microfluidic device of the microfluidic viscometer of FIG. 1, the image being captured by the imaging device at a point in time in accordance with an optional aspect of the disclosed concept;

FIG. 6 is an exemplary viscosity measurement analyzer integrated within the portable imaging device of FIG. 1 in accordance with an optional aspect of the disclosed concept;

FIGS. 7A-C illustrate the fluid fillings of the plurality of fluids within the microfluidic channels of the viscometer of FIG. 1 in accordance with an optional aspect of the disclosed concept;

FIGS. 8A-D are matrices depicting viscosity measurements of three fluids of interest using a reference fluid with a known viscosity, when no error is detected, in accordance with an optional aspect of the disclosed concept;

FIGS. 9A-D show matrices depicting viscosity measurements of the three fluids of interest with the reference fluid, when an error is detected, and auto-correcting the error upon detection in accordance with an optional aspect of the disclosed concept; and

FIGS. 10A-D show matrices depicting viscosity measurements of three fluids of interests having high viscosities in accordance with an alternative optional aspect of the disclosed concept.

### DETAILED DESCRIPTION OF THE INVENTION

The disclosed concept will now be described more fully with reference to the accompanying drawings, in which several embodiments are shown. This invention may, however, be embodied in many different forms and should not be construed as limited to the embodiments set forth here. Rather, these embodiments are examples of the invention, which has the full scope indicated by the language of the claims. Like numbers refer to like elements throughout. Unless indicated otherwise, the features characterizing the embodiments and aspects described in the following may be combined with each other, and the resulting combinations are also embodiments of the present invention.

Any headings used herein are for organizational purposes only and are not meant to limit the scope of the description or the claims. As used herein, the word “may” is used in a permissive sense (i.e., meaning having the potential to) rather than the mandatory sense (i.e., meaning must). Unless specifically set forth herein, the terms “a,” “an” and “the” are not limited to one element but instead should be read as meaning “at least one.” The terminology includes the words noted above, derivatives thereof and words of similar import.

As used herein, “and/or” means that either or both of the items separated by such terminology are involved. For example, the phrase “A and/or B” would mean A alone, B alone, or both A and B.

As used herein, “generally” means “in a general manner” relevant to the term being modified as would be understood by one of ordinary skill in the art.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The present invention describes a microfluidic viscometer and method for simultaneously measuring viscosities of one or more fluids of interest using the microfluidic viscometer including a microfluidic device that has a plurality of microfluidic channels and an imaging device configured to automatically and continuously acquire images of fluid flows within the microfluidic channels upon the introduction of a plurality of fluids including a fluid with known viscosity and a fluid of interest (hereinafter, also referred to as a sample fluid) to the microfluidic channels. The imaging device includes a viscosity measurement analyzer configured to automatically calculate viscosity parameters of the plurality of fluids based at least in part on the acquired images and measure the viscosity of the fluid of interest based at least in part on the viscosity parameters. The viscosity measurement analyzer measures the viscosity of the fluid of interest in part by automatically comparing the calculated viscosity parameters with the viscosity parameters of a reference fluid having viscosity known or measured directly or indirectly from using the fluid with known viscosity. The viscosity measurement analyzer also can correct an error in the viscosity measurements, and determine an accurate viscosity of each fluid of interest based on the comparison and/or auto-correction. The viscosity measurement analyzer can also make viscosity measurements of fluids of interest having high viscosities that may be beyond measurable range using an initial reference fluid.

The microfluidic device of the microfluidic viscometer includes a glass layer and a polydimethylsiloxane (PDMS) layer attached (e.g., bonded) on upper surface of the glass layer via, e.g., without limitation, an adhesive. The PDMS layer includes one or more microfabricated, microfluidic channels imprinted on its upper surface, each channel being identical in shape and dimensions to one another and open at one end allowing for the introduction of the plurality of fluids, each channel being connected to one another at the other end. Fluid filling in the microfluidic channels is accomplished by employing the gas solubility and permeability of the PDMS layer. The microfluidic device is fabricated by creating a vacuum in the PDMS walls of the device, thereby removing the soluble gas molecules in the PDMS. Once the microfluidic device is brought back to ambient air, the gas will diffuse back into the PDMS. The diffusion of the soluble gas into the PDMS generates a negative pressure in the microfluidic channels, and thus enables fluid filling therein. Owing to rigorous design connecting the microfluidic channels at other ends opposite the open ends, the pressure driving the flow in the microfabricated, microfluidic device is equally distributed within each individual microfluidic channel. This characteristic enables the variation in rate of filling of each fluid introduced in the device to be dependent principally on its viscosity.

In order to obtain viscosities of the one or more fluids of interest, the imaging device (e.g., without limitation, a camera in a smartphone, a tablet, a PDA, etc.) captures the progress (i.e., acquires images) of fluid filling in the microfluidic channels, and an automated image and data processing algorithm (i.e., the viscosity measurement analyzer), which is integrated within the imaging device, calculates the viscosities of the one or more fluids of interest by comparing the progress of fluid filling of the one or more fluids of interest with the progress of filling of one or more reference fluids. In order to ensure the accuracy of the viscosity measurement, the viscosity measurement analyzer automatically detects any error occurred in the calculated viscosities using auto-correlation of the viscosities measured and, upon such detection, automatically corrects the error.

The microfluidic viscometer according to the disclosed concept is advantageous over the conventional viscometers in that the microfluidic device is easy to manufacture and simple to use since it contains no moving parts unlike the conventional viscometers (e.g., the rotational cone and plate viscometers). Additionally, it requires as little as, e.g., without limitation, five microliters of a sample fluid to obtain an accurate measurement of the viscosity of the sample fluid in less than five minutes, thereby reducing the amount of sample fluids required and saving time to measure and analyze the viscosities of one or more sample fluids. In addition, unlike the conventional benchtop viscometers, the microfluidic viscometer is portable, and thus, capable of obtaining the viscosities of the sample fluids at any point of collection. The portability of the microfluidic viscometer is achieved by vacuum packaging of the microfluidic device and integrating the viscosity measurement analyzer in a portable imaging device (e.g., a camera embedded in a smart phone, a tablet, PDA, etc.). The vacuum packaging of the microfluidic device ensures that the flow-driving pressure within the PDMS layer is generated only when the PDMS layer is put in contact with ambient air. As such, the microfluidic device can be microfabricated and stored in a vacuum for a long period of time and used at the point of collection of the sample fluids. The integration of the viscosity measurement analyzer (e.g., without limitation, an automated image and data processing algorithm downloaded or installed in the portable imaging device) provides availability and access to the algorithm at any time and any place, thereby ensuring image acquisition, viscosity parameters calculation, analysis of data, and accurate viscosity measurements of the sample fluids at the point of sample collection. Such portability and capability of obtaining the accurate viscosity measurements at the point of sample collection not only removes time and labor for shipping the collected sample to a place in which the conventional benchtop viscometers are located, but also avoids possible spoilage or mistakes associated with the collected sample fluids. Furthermore, the microfluidic device is a single use, disposable device, and thus can be discarded upon completion of measuring viscosities of the fluid(s) of interest, thereby avoiding possible sample cross-contamination that conventional viscometers face upon cleaning thereof after each use despite the rigorous cleaning protocols applied.

Further, the integration of the viscosity measurement analyzer in the imaging device, which has a high frame rate image acquisition (e.g., without limitation, at least 50 images per second), allows for a high quantity of data points gathered. Such high quantity of data points allows for reduction of the required length of the microfluidic channels, and thus an increase of a number of microfluidic channels that can be imprinted on the upper surface of the PDMS layer, which in turn leads to an increase of a number of sample fluids whose viscosities can be measured simultaneously. Thus, the microfluidic viscometer provides parallel measurements of a plurality of sample fluids in a short time (e.g., less than five minutes), increasing the throughput as compared to the analytical methods for viscosity measurement employed by the conventional viscometers. When measuring a plurality of sample fluids, the viscosity measurement analyzer provides automated data measurement and analysis including at least one of: automated comparison of all fluids filling in all microfluidic channels independently of whether a reference fluid or a sample fluid is being measured therein; generation of a matrix of measured viscosities in order to determine if the ratios of viscosities of all fluids introduced in the microfluidic device correlate with respect to which fluid is being used as the reference fluid; automatic error detection if the value(s) of one or more calculated viscosities do not match the value(s) calculated using intermediate new reference fluid(s); automated reference selection of one or more sample fluids as a new reference fluid if the viscosity difference between a sample fluid and the initial reference fluid is too large for a direct result, the viscosities of the new reference fluid being calculated from direct or indirect comparison with the initial reference fluid; and/or automated detection of non-Newtonian behavior based on fluid filling rates. In addition, the viscosity measurement analyzer can simultaneously utilize a plurality of reference fluid, i.e., a plurality of fluids with known or measured viscosities for viscosity measurement of one or more sample fluids, thereby increasing the accuracy of viscosity measurement. Furthermore, due at least in part to its low volume requirement, portability, ease of use, specific geometric features, automated image collection, simultaneous viscosity measurements, comparison and analysis based on the high quantity data generation, the microfluidic viscometer allows for an increased range of measurable viscosity and accuracy of the viscosity measurements of a wide variety of fluids of interest, including viscosity measurement of non-Newtonian fluids. The viscosity measurement of a non-Newtonian fluid can use a similar approach for the extraction of filling rates developed for Newtonian fluids. Thus, the microfluidic viscometer expands areas of investigation including new avenues of investigation, which have not been possible with the conventional viscometers.

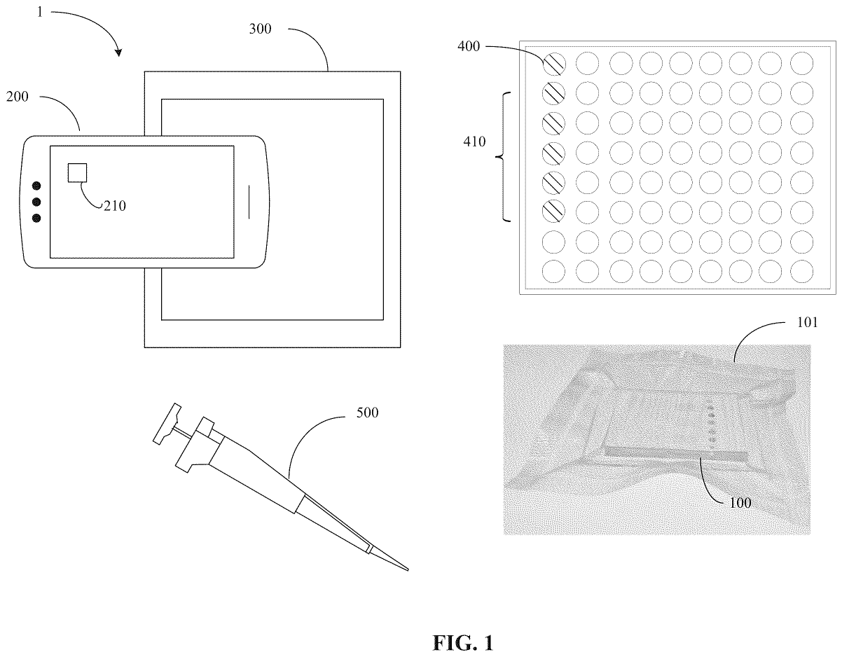

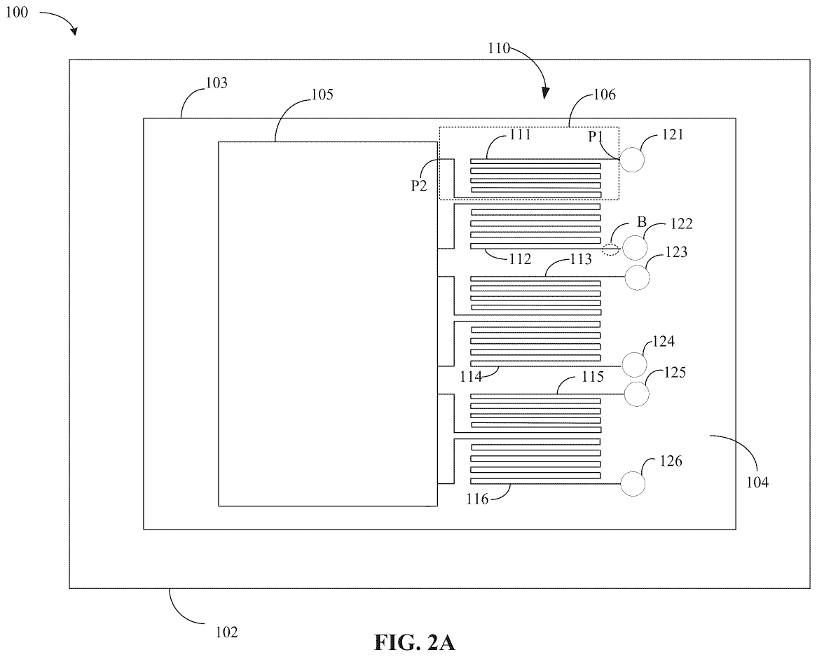

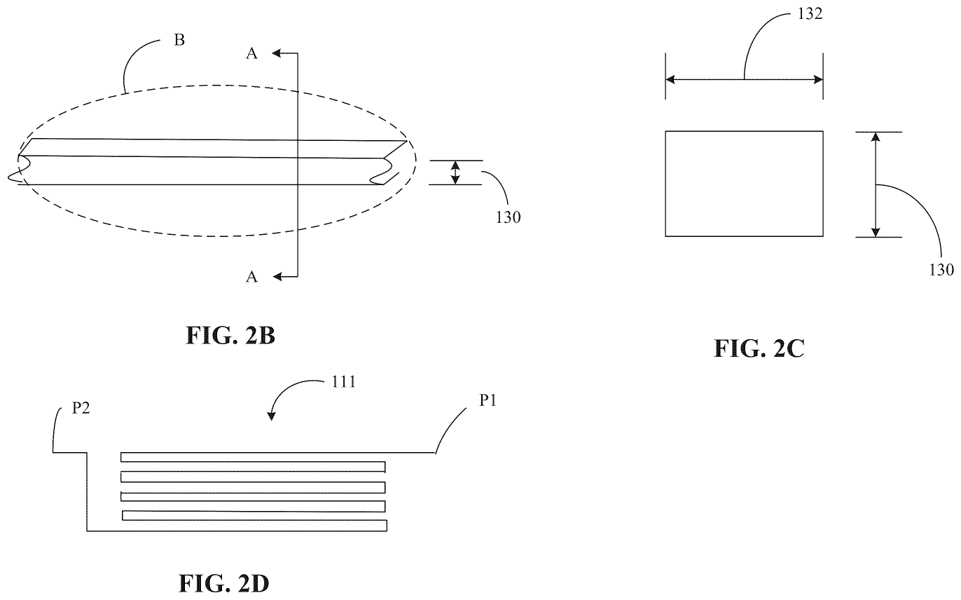

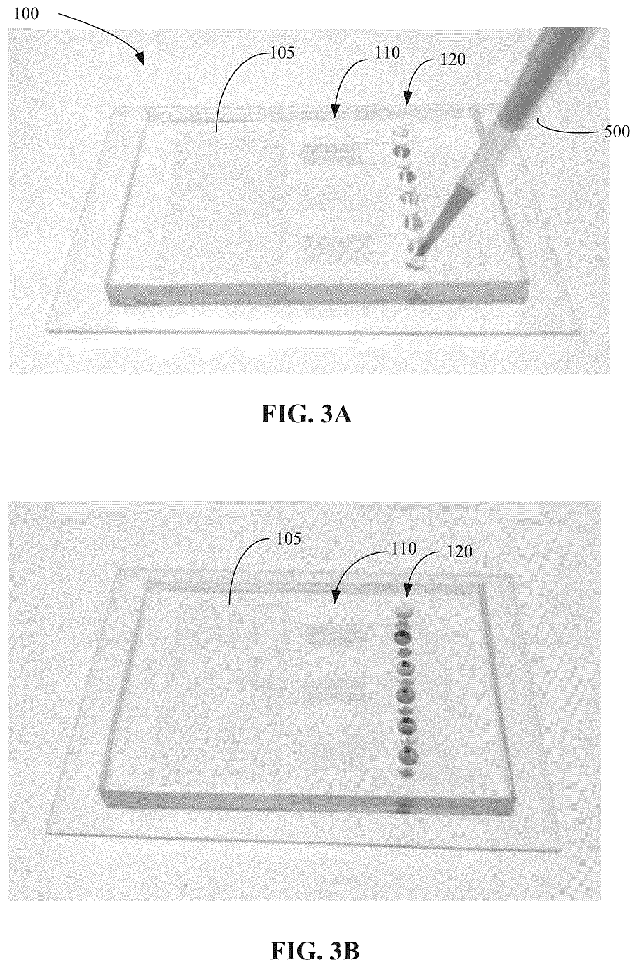

Referring now in detail to the figures, where like reference numerals refer to like parts throughout, FIGS. 1 and 4 show an exemplary microfluidic viscometer 1 including a microfluidic device 100 and an imaging device 200 for obtaining viscosity of a fluid of interest 410 (hereinafter, also referred to as sample fluid) using a reference fluid 400 of known viscosity at points of sample fluid collection according to an optional, non-limiting embodiment of the disclosed concept and FIGS. 2A-3B depict various aspects (e.g., dimensions and use) of the microfluidic device 100 of FIG. 1. Optionally, the reference fluid 400 may be deionized water.

Polydimethylsiloxane (PDMS), also known as dimethylpolysiloxane or dimethicone, is classified as a silicone polymer and can be utilized for a variety of purposes from industrial lubrication and biomaterial application. The chemical formula of PDMS is CH₃[Si(CH₃)₂O]ₙSi(CH₃)₃, where n is the number of repeating monomer [Si(CH₃)₂O] units. It has become popular in biomedical applications due to its properties including physiological indifference, resistance to biodegradation, biocompatibility, chemical stability, gas permeability, optical transparency and simple fabrication by replica molding. It has been widely utilized in micropumps, catheter surfaces, dressings and bandages, microvalves, drug delivery vehicles, optical systems, in vitro study of diseases, implants, photonics, and microfluidics.

The microfluidic device 100 includes a glass layer 102 and a PDMS layer 103 attached on top of the glass layer 102, the PDMS layer 103 having a plurality of microfluidic channels 111-116 each having inlets 121-126 at one end P1 and being coupled to one another 111 via a single chamber 105 at distal end P2, the microfluidic channels 111-116 being configured to convey a plurality of fluids 400,410 from respective inlets 121-126 to the another end P2 upon introduction of the plurality of fluids 400,410 to the inlets 121-126. The plurality of fluids 400,410 includes the fluid 400 with known viscosity and the fluid of interest 410 with unknown viscosity. The microfluidic device 100 does not include any layer disposed on top of the PDMS layer 103. Placing the PDMS layer 103 as a top layer of the microfluidic device 100 allows an unobstructed visualization of fluid filling within the microfluidic channels 111-116, thereby providing more accurate data analysis based on an unimpeded image acquisition by the imaging device 200. For example, such placement can reduce visual artifacts due to reflection and refraction that could result when another glass layer is placed on the top surface of the PDMS layer 103. It also reduces the manufacturing of the microfluidic device 100 to one bonding step, thereby saving manufacturing time and cost. The single chamber 105 includes a vacuum chamber, and may have any dimensions suitable for microfluidic viscosity measurements. Optionally, it can have a height of 50 μm, width of 2 cm and a length of 3.4 cm.

Optionally, in some example embodiments, instead of a flat glass layer 102 bonded to a PDMS layer 103 that contains the channels 111-116, the microfluidic device could be set up as a flat PDMS layer that is bonded to a layer containing the microfluidic channels. A broad range of materials could be used for the patterning of microchannels including (but not limited to) glass, poly(methyl methacrylate) (PMMA), Polycarbonate (PC), Cyclic olefin copolymer (COC) for example. These can be beneficial in terms of manufacturing time and cost. Replication of microfluidic structures in PDMS has a high cost of manufacturing while plastic devices are usually preferred for high volume manufacturing due to the low unit cost. In these example embodiments the flat PDMS layer does not require any microfluidic channels embedded, and thus is simpler (and cheaper) to produce. Optionally, in some other example embodiments, Flexdym may be used instead of PDMS. Optionally, the microfluidic device may be formed with a copolymer composed a methacrylate and PDMS. The composition provides the gas solubility required for the vacuum driven flow, and render the microfluidic device to be compatible with other manufacturing methodologies.

PDMS is a type of polymeric organosilicon compound and can be used in fabricating microfluidic devices (e.g., without limitation, chips, electronics parts, viscometers, etc.) due to its optical transparency, easy fabrication, flexibility and low cost. Fluid filling in the microfluidic device 100 is accomplished by employing the gas solubility and permeability of the PDMS. The microfluidic device 100 is fabricated by creating a vacuum in the PDMS walls of the device 100, thereby removing the soluble gas (e.g., air) molecules in the PDMS. The microfluidic device 100 is then vacuum packaged 101. The vacuum packaging 101 ensures that flow driving pressure is generated in the PDMS only when the microfluidic device 100 comes in contact with ambient air. As such, the microfluidic device 100 can be fabricated and stored in a vacuum for a long period, and used at a point of sample fluid collection. The PDMS layer 103 includes the plurality of microfluidic channels 111-116 imprinted on its upper surface 104 and the inlets 121-126 configured to introduce the fluids 400,410 into the microfluidic channels 111-116 at the one end P1 via a pipette 500. The microfluidic channels 111-116 are connected to one another at the distal end P2 such that the pressure driving the flow in the microfluidic device 100 is equally distributed within each individual microfluidic channel 111-116. This enables the variation in rate of filling of each fluid 410 introduced in the device 100 to be dependent principally on its viscosity. While FIGS. 1, 2A, 3A-B, and 4 show six identical microfluidic channels 111-116, this is for illustrative purposes only and there can be less or more microfluidic channels based on the circumstance, preferences or needs. The plurality of microfluidic channels 111-116 allows for simultaneous, parallel viscosity measurements of multiple fluids. Such parallelization of viscosity measurements results in a significant increase in the throughput as compared to the throughputs afforded by the conventional viscometers. It also increases the measurable viscosity range, optionally from 1 mPa·s(cP) to above 650 mPa·s.

FIGS. 2B-2D illustrate an exemplary shape and dimensions of the microfluidic channel 111, but it will be understood that the description of the microfluidic channel 111 also applies to the rest of the microfluidic channels 112-116 as all of the microfluidic channels 111-116 are identical. While the shape of cross-section of the microfluidic channels 111-116 is rectangular in FIGS. 2B-C, this is for illustrative purposes only, and thus the microfluidic channels can have cross-section of any suitable shape, e.g., circular, square, rectangular, etc. The dimensions of a microfluidic channel 111 may include any height, width or length suitable for microfluidic viscosity measurements. Optionally, the height 130, width 132, and length of the microfluidic channel 111 may be 50 μm, 400 μm, and 8 cm, respectively. Optionally, the height 130, width 132 and the length may be 50 μm, 100 μm, and 10 cm, respectively. The length of the microfluidic channel 111 starts at the one end P1 and ends at the distal end P2. The cross-section of the microfluidic channel 111 is engineered to be sufficiently large to allow a better visualization of the fluid filling within the channel 111. The length of the microfluidic channel 111 is relatively short (e.g., 8 cm, 10 cm) due to the high frame rate image acquisition capacity of the imaging device 200, thereby allowing for an increased number of microfluidic channels to be added in the PDMS layer 103. At the one end P1 of the microfluidic channel 1, an inlet 121 is formed for introducing a fluid into the microfluidic channel 111. At the distal end P2, the microfluidic channel 111 is connected to other microfluidic channels 112-116.

In operation, a user removes the vacuum packaging 101 from the microfluidic device 100. Upon the removal of the vacuum packaging 101, the microfluidic device 100 becomes exposed to ambient air and the air diffuses back into the PDMS layer 103. The diffusion of the air into the PDMS layer 103 is driven from the inside of the microfluidic channels 111-116 and from the top surface of the PDMS layer 103, which generates a negative pressure in the microfluidic channels 111-116 and enables fluid filling therein. The user then introduces the reference fluid 400 and the sample fluids 410 into the inlets 121-126 via a pipette 500 as shown in FIGS. 3A-B. Optionally, the amount of the reference fluid 400 and sample fluids 410 introduced to the microfluidic channels 111-116 may be approximately 5 μL each. Optionally, the amount of each fluid introduced may be more or less than 5 μL. The fluids 400,410 may be available at the point of sample fluid collection. Due to the identical microfluidic channels 111-116 being connected to one another at the distal end P2, the negative pressure driving the fluid flow in the PDMS layer 103 is equally distributed within each microfluidic channel 111-116. This equal distribution of the negative pressure allows variations in the flow rate Q of each fluid 400,410 introduced in the microfluidic device 100 be dependent principally on its own viscosity. The imaging device 200 captures the progress of fluid filling in microfluidic channels 111-116, including the variations in the flow rate Q of each fluid 400,410, and a viscosity measurement analyzer 210 integrated in the imaging device 200 starts to measure viscosities of the sample fluids based on the images of the fluid filling in the microfluidic channels 111-116 when the last fluid 400, 410 is introduced to respective inlet. Since the introduction of the last fluid 400,410 is used to control the start of the viscosity measurement, the microfluidic device 100 does not require a control channel structured to assess start of the viscosity measurement of the plurality of fluids 400,410. This allows for more microfluidic channels to be added to the surface of the PDMS layer 103.

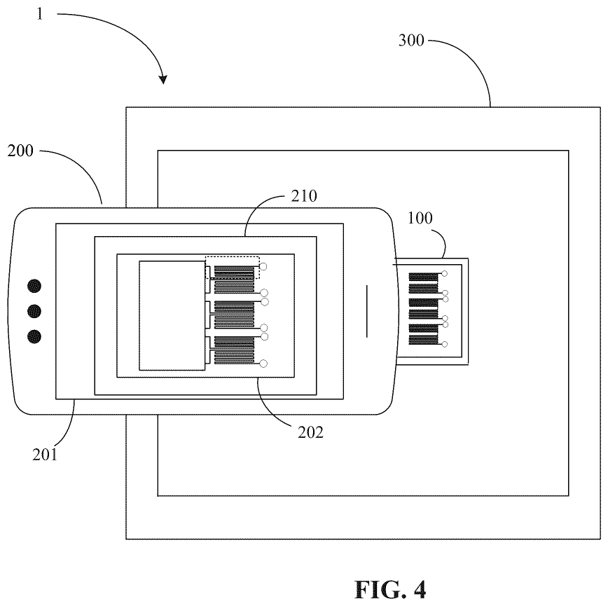

Optionally, the imaging device 200 is a camera embedded in a smart phone, a tablet, PDA, etc., that is portable. The imaging device 200 is configured to automatically and continuously acquire images of fluid flows within the microfluidic channels 111-116 upon the introduction of the plurality of fluids 400,410. The imaging device 200 has a display 201 that displays the acquired images 202 of fluid flows of the plurality of fluids 400,410 as shown in FIG. 4. FIG. 5 illustrates an image 202 acquired by the imaging device 200 at a point in time and depicts the fluid flowing in each microfluidic channel 111-116 at that point in time. To measure the viscosity of the sample fluid, the viscosity measurement analyzer 210 is configured to automatically calculate viscosity parameters of the plurality of fluids 400,410 based at least in part on the acquired images, analyze and compare the viscosity parameters, and measure the viscosity of the sample fluid 400 based at least in part on the analyzed and compared viscosity parameters. In FIG. 5, the fluid of known viscosity 400 is introduced in the microfluidic channel 111, and the five sample fluids 410 are introduced in the microfluidic channels 112-116. However, this is for illustrative purpose only, and any of the plurality of fluids 400,410 can be introduced in any microfluidic channel and/or any number of sample fluids can be introduced in the microfluidic channels. The viscosity parameters including at least the fluid fillings or flow rates Q and distances travelled by the sample fluids 112-116 acquired and calculated are compared to those of the fluid of known viscosity 400, and the viscosities of the sample fluids 112-116 are then measured. Optionally, the acquisition of the images, calculation of viscosity parameters, analysis and comparison of the viscosity parameters, and viscosity measurements of the fluids of interest 410 are completed in less than five minutes. The imaging device 200 has a high frame rate of image acquisition, optionally, a frame rate of at least 50 frames per second. The high frame rate of image acquisition provides a high quantity of data points collected for analysis, optionally, more than 1,000 images per viscosity measurement. Such a high quantity of data points allows for a reduction of required channel length and an increase in a number of microfluidic channels that can be included in the PDMS layer 103.

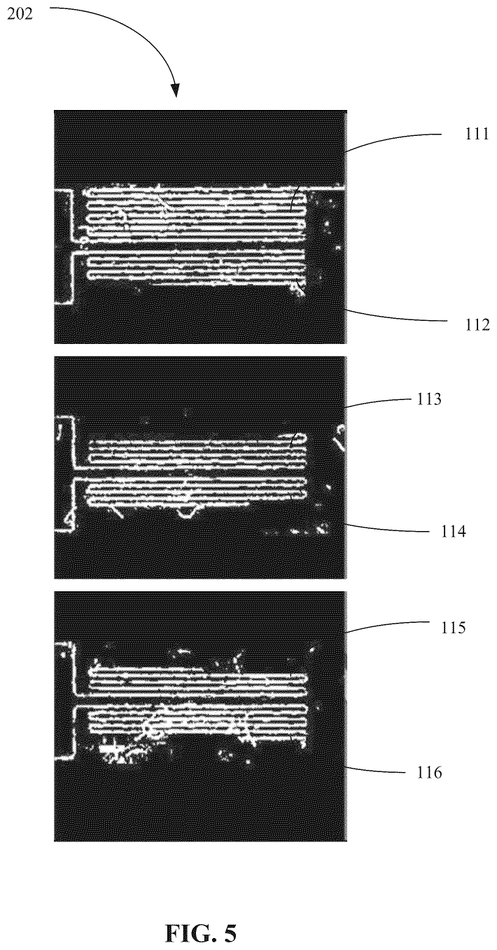

The viscosity measurement analyzer 210 may be downloaded from the cloud or installed as software application within the imaging device 200. The viscosity measurement analyzer 210 is stored in a memory within a processing unit (e.g., without limitation, a controller, a microcontroller, a CPU, etc.) and/or updatable via the cloud. Optionally, it may be available at a local or remote workstation communicatively coupled to the imaging device 200 and accessible via the imaging device 200 in a wired or wireless connection. FIG. 6 illustrates the viscosity measurement analyzer 210 and the components thereof.

As illustrated in FIG. 6, the viscosity measurement analyzer 210 includes a reference fluid selector configured to select a reference fluid from the plurality of fluids. Optionally, the viscosity measurement analyzer 210 includes a viscosity calculator 216 that is configured to calculate the viscosity parameters of the plurality of fluids upon introduction of last fluid of the plurality of fluids and measure the viscosity of the sample fluid based at least in part on the viscosity parameters. The viscosity parameters include at least one of flow rates Q, distance L travelled by the plurality of fluids 400,410, a ratio

$$\frac{{η}_{sample}}{{η}_{ref}}$$

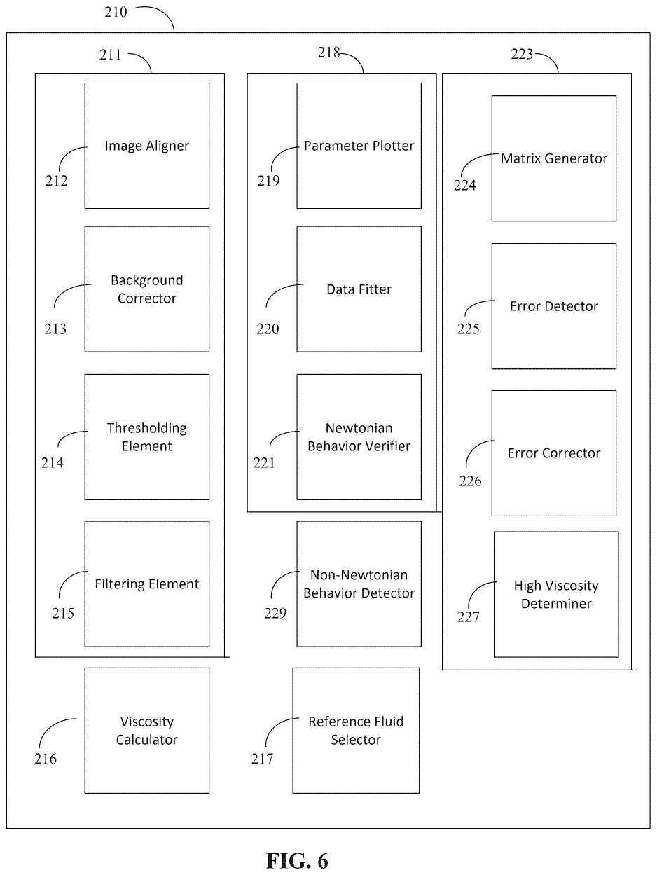

of the viscosity ηₛₐₘₚₗₑ of the sample fluid to a viscosity η_{ref} of the reference fluid. Flow rate Q for Newtonian fluid in a microfluidic channel (e.g., without limitation, a microfluidic channel 118 having a circular cross section as shown in FIGS. 7A-C) is:

$$Q = \frac{Δ P}{{R}_{H}} = Δ P \frac{{A}^{2}}{η {LC}_{geom}} \qquad EQ . 1$$

where ΔP is the pressure drop between the one end P₁ and the distal end P₂ (i. e., ΔP=P₁−P₂), R_{H} is hydraulic resistance to flow, A is the area of the cross section 141 of each microfluidic channel 111-116, C_{geom} is the constant related to channel geometry (e.g., C_{geom} is 32 for a rectangular cross section) and 77 is the viscosity of the fluid. When the viscosity of a fluid is unknown, it can be measured using the reference fluid whose viscosity is known or measured directly or indirectly from using the known viscosity of a fluid. That is, by measuring the distances 143,144 that the fluids traveled and flow rates Qₛₐₘₚₗₑ,Q_{ref} of the reference and sample fluids, the ratio

$$\frac{{η}_{sample}}{{η}_{ref}}$$

of the viscosity of the sample fluid 410 and the viscosity of the reference fluid 400 can be determined. First, ΔPₛₐₘₚₗₑ and ΔP_{ref} are equal since they are both the pressure difference between P₁ and the outlet P₂:

ΔPₛₐₘₚₗₑ−ΔP_{ref} EQ. 2

Based on EQ. 1, this means:

QₛₐₘₚₗₑRₛₐₘₚₗₑ=Q_{ref}R_{ref} EQ 0.3

Replacing Rₛₐₘₚₗₑ,R_{ref} with

$$\frac{{C}_{geom} {η}_{sample} {L}_{sample}}{{A}^{2}} , \frac{{C}_{geom} {η}_{ref} {L}_{ref}}{{A}^{2}} ,$$

respectively, based on EQ. 1, EQ. 3 becomes:

$${Q}_{sample} \frac{{C}_{geom} {η}_{sample} {L}_{sample}}{{A}^{2}} = {Q}_{ref} \frac{{C}_{geom} {η}_{ref} {L}_{ref}}{{A}^{2}} \qquad EQ . 4$$

The ratio of the viscosity of the sample fluid 410 and the viscosity of the reference fluid 400 then can be written as:

$$\frac{{η}_{sample}}{{η}_{ref}} = \frac{{Q}_{ref} {L}_{ref}}{{Q}_{sample} {L}_{sample}} \qquad EQ . 5$$

Since flow rates and distances travelled by the sample and reference fluids have already been calculated, the ratio of the viscosity ηₛₐₘₚₗₑ of the sample fluid 410 to the viscosity η_{ref} of the reference fluid 400 is easily obtained. Then, the viscosity ηₛₐₘₚₗₑ of the sample fluid 410 can be obtained by multiplying the known viscosity η_{ref} of the reference fluid 400 by the ratio of the viscosity ηₛₐₘₚₗₑ of the sample fluid 410 to the viscosity η_{ref} of the reference fluid 400.

Optionally, the viscosity measurement analyzer 210 may include a single sample fluid analyzer 218 that, together with the other components of the viscosity measurement analyzer 210, performs viscosity parameter calculation, analysis and comparison of the viscosity parameters, and viscosity measurement of a single fluid of interest 410. To obtain viscosity of the single fluid of interest 410, the reference fluid selector 217 selects as a reference fluid the fluid with known viscosity 400. Optionally, the reference fluid 400 may have viscosity measured directly or indirectly from using a fluid with known viscosity 410 previously. The viscosity calculator 216 simultaneously calculates the viscosity parameters of the plurality of fluids and measures the viscosity of the fluid of interest 410 based at least in part on the calculated viscosity parameters. In measuring the viscosity, the viscosity calculator 216 analyzes and compares the calculated viscosity parameters of the single fluid of interest 410 to those of the reference fluid 400. Optionally, the single sample fluid analyzer 218 includes a parameter plotter 219 configured to automatically plot the flow rate Q_{ref} multiplied by the distance L_{ref} of the reference fluid 400 with respect to the flow rate Qₛₐₘₚₗₑ multiplied by the distance Lₛₐₘₚₗₑ of the single fluid of interest 410. Optionally, the single sample fluid analyzer 218 also includes a data fitter 220 configured to fit data including the viscosity parameters and the plotted viscosity parameters over a plurality of points in time. The viscosity calculator 216 measures the viscosity of the single fluid of interest 410 based at least in part on the data fitted by the data fitter 220. Optionally, the single sample fluid analyzer 218 includes a Newtonian behavior verifier 221 configured to automatically verify Newtonian behavior of the single fluid of interest 410 based on the data fitted over the plurality of points in time. The viscosity calculator 216 calculates the viscosity of the single fluid of interest 410 based at least in part on the fitted data and the verification of Newtonian behavior of the single fluid of interest 410. In some examples including a single non-Newtonian fluid of interest, the viscosity of the single non-Newtonian fluid of interest is made using a non-Newtonian behavior detector 229 instead. The non-Newtonian behavior detector 229 is discussed further later. Optionally, more than one reference fluid can be used for obtaining the viscosity of the single fluid of interest 410, thereby increasing accuracy of the viscosity measurement. The reference fluids can be fluids with known viscosities, fluids with viscosities measured directly or indirectly using the fluid(s) of known viscosities, or any combination thereof. Optionally, the user may input the viscosity of the reference fluid 400 to the viscosity measurement analyzer 210, which is then used to calculate the viscosity of the sample fluid 410.

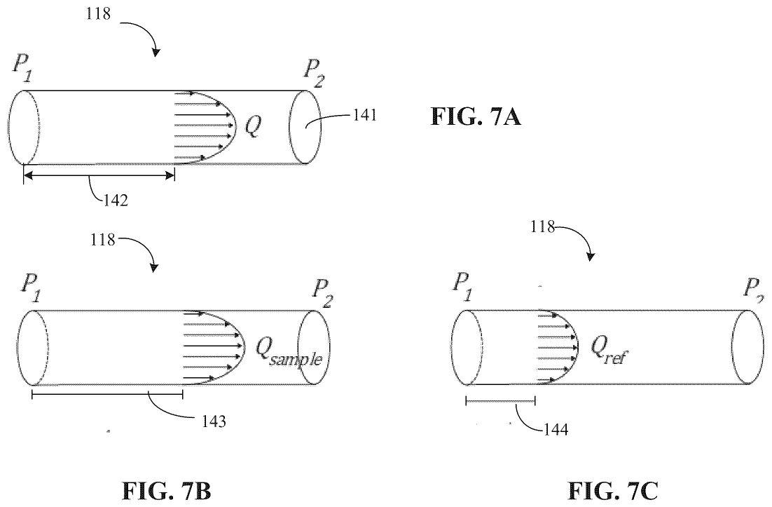

Optionally, the viscosity measurement analyzer 210 includes a multiple sample fluid analyzer 223 that, in tandem with other components of the viscosity measurement analyzer 210, obtains viscosities of a plurality of fluids of interest 410. Optionally, the viscosity measurement analyzer 210 may perform simple analysis, which provides single comparison of the viscosity parameters and viscosity measurements of the plurality of fluids of interest 410 to those of one reference fluid only as shown in FIG. 8A. Alternatively, and optionally, the viscosity measurement analyzer 210 may perform multiple comparisons of the viscosity parameters and viscosity measurements of the plurality of fluids of interest 410 to those of an initial reference fluid and/or one or more of the plurality of fluids of interest 410 that are acting as temporary new reference fluids as shown in FIGS. 8B-D. That is, each fluid of interest whose viscosity measurement is complete using a previous reference fluid becomes a new reference fluid for the remaining fluid(s) of interest until the viscosity measurements of all of the plurality of fluids of interest 410 are complete. While FIGS. 8A-10D illustrate viscosity measurements of three fluids of interest, this is for illustrative purposes only and more of less number of fluids of interest can be measured by the microfluidic viscometer 1. Further, the multiple comparison analysis becomes more robust with a larger number of sample fluids that are measured simultaneously. Optionally, the fluid of known viscosity 400 may be a plurality of fluids of known viscosity 400 that are used simultaneously to measure viscosities of the fluids of interest 410. For example, the reference selector 217 can select the plurality of fluids of known viscosity 400 as the reference fluids to measure viscosities of the fluids of interest 410 initially.

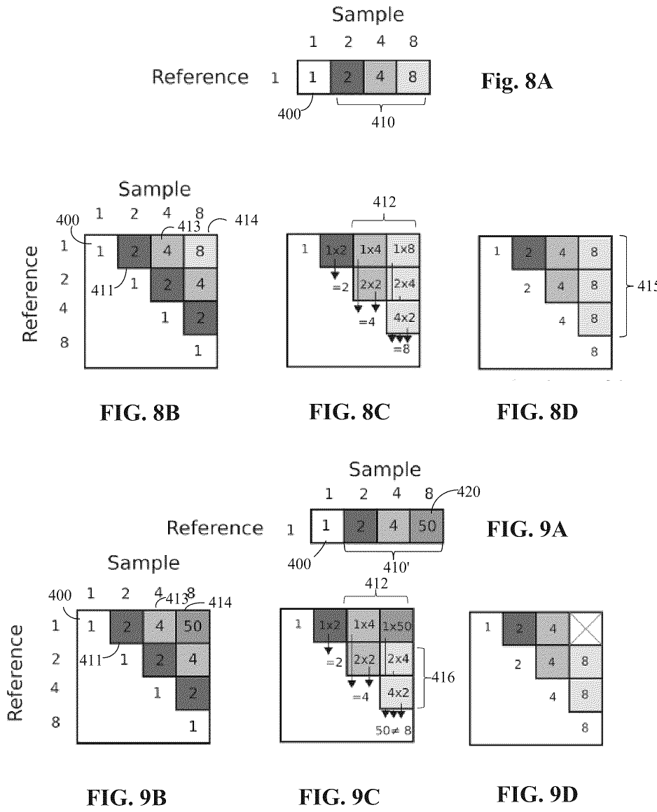

FIGS. 8A and 9A illustrate single comparison analysis of viscosity measurements of three fluids of interest 410 each having viscosities of 2 cP, 4 cP, and 8 cP to a single reference fluid 400 with known viscosity. The reference selector 217 selects the fluid with known viscosity 400 as the reference fluid. Optionally, the reference fluid may be a fluid with viscosity measured directly or indirectly using a fluid with known viscosity previously. The viscosity calculator 216 simultaneously calculates the viscosity parameters of the plurality of fluids 400,410 and measures viscosities of the plurality of fluids of interest 410 using the viscosity η_{ref} of the reference fluid 400 and viscosity ratios

$$\frac{{η}_{sample}}{{η}_{ref}}$$

between the viscosities ηₛₐₘₚₗₑ of the plurality of fluids of interest 410 and the viscosity η_{ref} of the reference fluid 400. In measuring the viscosities, the viscosity calculator 216 automatically analyzes and compares the calculated viscosity parameters of the fluids of interest 410 to those of the reference fluid 400. The comparison is made independently of whether the fluid of known viscosity 400 or a fluid of unknown viscosity 410 is being measured therein. Upon determination that the viscosities of all of the plurality of fluids of interest 410 are obtained using the single reference fluid 400, the viscosity measurement analyzer 210 deems the viscosity measurements under the single comparison analysis successful.

However, while using the single comparison analysis may be sufficient where there is no error in the viscosity measurements as shown in FIG. 8A, it may not be sufficient where there is an error since it may yield an erroneous, but undetected, viscosity measurement 420 as shown in FIG. 9A. In FIG. 9A, there is a viscosity measurement error 420 yielding 50 cP for a fluid of interest whose viscosity should have been measured as 8 cP. However, since the single comparison analysis is used, the error 420 is undetected, and thus the user will deem 50 cP is the viscosity of that fluid of interest. As such, with the single comparison analysis, one or more viscosity measurements of the plurality of fluids of interest 410 may not be complete even if the microfluidic viscometer 1 returns the viscosity measurement for each fluid of interest. In order to avoid such undetected error and increase the accuracy of the viscosity measurements, the multiple sample fluid analyzer 223 can be used to perform multiple comparison analysis by the multiple sample fluid analyzer 223 in tandem with other components of the viscosity measurement analyzer 210. Optionally, the multiple sample fluid analyzer 223 may include a matrix generator 224 configured to generate a matrix of the viscosity measurements of the plurality of fluids of interest and perform correlation of the viscosity measurements, an error detector 225 configured to detect an error in the viscosity measurements, and an error corrector 226 configured to correct the error. Optionally, the multiple sample fluid analyzer 223 may also include a high viscosity detector 227 for high viscosity measurements.

FIGS. 8B-D illustrate the multiple comparison analysis of viscosity measurements of three fluids of interest 410 each having viscosities of 2 cP, 4 cP, and 8 cP to the reference fluid 400 with known viscosity of 1 cP as well as one or more of the fluids of interest 410 that can act as temporary, intermediate reference fluids where no error in viscosity measurements of the plurality of fluids of interest 410 has occurred. First, the reference selector 217 selects the fluid with known viscosity 400 as the reference fluid. Optionally, the reference fluid may be a fluid with viscosity measured directly or indirectly using a fluid with known viscosity previously. The viscosity calculator 216 simultaneously calculates the viscosity parameters of the plurality of fluids 400,410 and measures viscosities of the plurality of fluids of interest 410 using the viscosity η_{ref} of the reference fluid 400 and viscosity ratios

$$\frac{{η}_{sample}}{{η}_{ref}}$$

between the viscosities ηₛₐₘₚₗₑ of the plurality of fluids of interest 410 and the viscosity η_{ref} of the reference fluid 400. In measuring the viscosities, the viscosity calculator 216 automatically analyzes and compares the calculated viscosity parameters of the fluids of interest 410 to those of the reference fluid 400.

Next, the viscosity measurement analyzer 210 determines that the plurality of fluids of interest 410 comprises a first fluid of interest 411 whose viscosity measurement is complete using the viscosity of the reference fluid 400 and the viscosity ratios between the viscosities of the plurality of fluids of interest 410 and the viscosity of the reference fluid 400, and a second fluid of interest 412 whose viscosity measurement is not yet complete. The reference fluid selector 217 then selects the first fluid of interest 411 as a new reference fluid. That is, the first fluid of interest 411 will act as a temporary intermediate reference fluid for the second fluid of interest 412. The viscosity calculator 216 then simultaneously calculates the viscosity parameters of the plurality of fluids of interest 410 and measures viscosity of the second fluid of interest 412 using the viscosity η_{ref} of the new reference fluid 411 and viscosity ratios

$$\frac{{η}_{sample}}{{η}_{ref}}$$

between the viscosities ηₛₐₘₚₗₑ of the plurality of fluids of interest 410 and the viscosity η_{ref} of the new reference fluid 411. Next, the viscosity measurement analyzer 210 determines that the second fluid of interest 412 includes a third fluid of interest 413 whose viscosity measurement is complete using the viscosity of the new reference fluid 411 and the viscosity ratios between the viscosities of the plurality of fluids 400 and the viscosity of the new reference fluid 411, and remaining fluid of interest 414 whose viscosity measurement is not yet complete. If the viscosity measurement analyzer 210 determines that the second fluid of interest 412 does not include the remaining fluid of interest 414, the viscosity measurement analyzer 210 determines that the viscosity measurements of all of the plurality of fluids of interest 410 are successful and complete.

Upon determining that the second fluid of interest 412 includes the third fluid of interest 413 and the remaining fluid of interest 414, the reference fluid selector 217 selects the third fluid of interest 413 as the new reference fluid, and the viscosity calculator 216 calculates viscosity parameters of the second fluid of interest 412 and measures viscosity of the remaining fluid of interest 414 using the viscosity η_{ref} of the new reference fluid 413 and viscosity ratios

$$\frac{{η}_{sample}}{{η}_{ref}}$$

between the viscosity ηₛₐₘₚₗₑ of the remaining fluid of interest 414 and the viscosity η_{ref} of the new reference fluid 414. Optionally, the viscosity calculator 216 measures the viscosity of the remaining fluid of interest 414 by using the average value (i.e., 8 cP) of the viscosities of the remaining fluid of interest 414 measured using the reference fluid 400 and the first fluid of interest 411 as the new reference fluid as shown in FIG. 8C. Optionally, the matrix generator 224 automatically generates a matrix of viscosity measurements using each reference fluid 400, 411, 413, and determines if all of the viscosity measurements of the remaining fluid of interest 414 correlate, i.e., the viscosities of the remaining fluid 414 measured using different reference fluids 400,411, 413 are the same. If it is determined that the viscosities of the remaining fluid of interest 414 measured using the reference fluid 400 and the new reference fluid 411,413 correlate as shown in FIG. 8D, the viscosity measurement analyzer 210 determines that the viscosity measurement of the remaining fluid of interest 414 has been successful based at least in part on the correlation 415. Then, the viscosity measurement analyzer 210 determines if the remaining fluid of interest 414 includes any further remaining fluid whose viscosity measurement has not been complete. If it is determined that the remaining fluid of interest 414 does not include any further remaining fluid, the viscosity measurement analyzer 210 determines that the viscosity measurements of all of the plurality of fluids of interest 410 are successful and complete. If it is determined that the remaining fluid of interest 414 includes any further remaining fluid, the viscosity measurement analyzer 210 performs the viscosity measurements of the further remaining fluid of interest until the viscosity measurements of all of the further remaining fluid of interest are successful and complete.

FIGS. 9B-D illustrate the multiple comparison analysis of viscosity measurements of three fluids of interest 410′ each having viscosities of 2 cP, 4 cP, and 8 cP to the reference fluid 400 with known viscosity of 1 cP as well as one or more of the fluids of interest 410′ that can act as temporary, intermediate reference fluids where an error 420 in viscosity measurements of the plurality of fluids of interest 410′ has occurred. The error 420 lies in that the viscosity measurement analyzer 210 yielded a viscosity measurement of 50 cP for the fluid of interest whose viscosity should have been measured as 8 cP as shown in FIGS. 9A-C. Initially, the reference selector 217 selects the fluid with known viscosity 400 as the reference fluid. The viscosity calculator 216 simultaneously calculates the viscosity parameters of the plurality of fluids 400,410′ and measures viscosities of the plurality of fluids of interest 410′ using the viscosity η_{ref} of the reference fluid 400 and viscosity ratios

$$\frac{{η}_{sample}}{{η}_{ref}}$$

between the viscosities ηₛₐₘₚₗₑ of the plurality of fluids of interest 410′ and the viscosity η_{ref} of the reference fluid 400. In measuring the viscosities, the viscosity calculator 216 automatically analyzes and compares the calculated viscosity parameters of the fluids of interest 410′ to those of the reference fluid 400. At this point, the error 420 is undetected, but the multiple comparison continues similarly as if no error has occurred as described with reference to FIGS. 8B-D.

Next, the viscosity measurement analyzer 210 determines that the plurality of fluids of interest 410′ comprises a first fluid of interest 411 whose viscosity measurement is complete using the viscosity of the reference fluid 400 and the viscosity ratios between the viscosities of the plurality of fluids of interest 410′ and the viscosity of the reference fluid 400, and a second fluid of interest 412 whose viscosity measurement is not yet complete. The reference fluid selector 217 then selects the first fluid of interest 411 as a new reference fluid. That is, the first fluid of interest 411 will act as a temporary intermediate reference fluid for the second fluid of interest 412. The viscosity calculator 216 then simultaneously calculates the viscosity parameters of the plurality of fluids of interest 410′ and measures viscosity of the second fluid of interest 412 using the viscosity η_{ref} of the new reference fluid 411 and viscosity ratios

$$\frac{{η}_{sample}}{{η}_{ref}}$$

between the viscosities ηₛₐₘₚₗₑ of the plurality of fluids of interest 410′ and the viscosity η_{ref} of the new reference fluid 411. Next, the viscosity measurement analyzer 210 determines that the second fluid of interest 412 includes a third fluid of interest 413 whose viscosity measurement is complete using the viscosity of the new reference fluid 411 and the viscosity ratios between the viscosities of the plurality of fluids 400 and the viscosity of the new reference fluid 411, and remaining fluid of interest 414 whose viscosity measurement is not yet complete.

Upon determining that the second fluid of interest 412 includes the third fluid of interest 413 and the remaining fluid of interest 414, the reference fluid selector 217 selects the third fluid of interest 413 as the new reference fluid, and the viscosity calculator 216 calculates viscosity parameters of the second fluid of interest 412 and measures viscosity of the remaining fluid of interest 414 using the viscosity η_{ref} of the new reference fluid 413 and viscosity ratios

$$\frac{{η}_{sample}}{{η}_{ref}}$$

between the viscosity ηₛₐₘₚₗₑ of the remaining fluid of interest 414 and the viscosity η_{ref} of the new reference fluid 414. Optionally, the matrix generator 224 automatically generates a matrix of viscosity measurements using each reference fluid 400, 411, 413, and determines if all of the viscosity measurements of the remaining fluid of interest 414 correlate, i.e., the viscosities of the remaining fluid 414 measured using different reference fluids 400,411, 413 are the same.

Based on a determination that the viscosities of the remaining fluid of interest 414 measured using the reference fluid 400 and the new reference fluid 411,413 do not correlate as illustrated in FIGS. 9B-C, the viscosity measurement analyzer 210 performs automatically an error correction. In FIGS. 9B-C, the error 420 yielding viscosity measurement of 50 cP using the reference fluid 400 does not correlate with the viscosity measurements of 8 cP of the remaining fluid 414 measured using the new reference fluid 411,413. For the error correction, the error detector 225 detects the viscosity measurement 420 of the remaining fluid of interest 414 that does not correlate with other viscosity measurements 416 of the remaining fluid of interest 414. That is, the error detector 225 detects that the viscosities of the remaining fluid of interest 414 using the new reference fluid 411,143 are equal (8 cP), i.e., correlate, whereas the viscosity measurement 420 of 50 cP is an outlier, and thus, an error. The error corrector 226 then excludes the erroneous viscosity measurement 420 that does not correlate with the other viscosity measurements 416 of the remaining fluid of interest 414. The viscosity calculator 216 then measures the viscosity of the remaining fluid of interest 414 using at least one of the new reference fluid 413 and an average of the other viscosity measurements 416 of the remaining fluid of interest 414. The viscosity measurement analyzer 210 then determines if the remaining fluid of interest 414 includes a further remaining fluid whose viscosity measurement is not complete. If it is determined that the remaining fluid of interest 414 does not include any further remaining fluid, the viscosity measurement analyzer 210 determines that the viscosity measurements of all of the plurality of fluids of interest 410 are successful and complete. If it is determined that the remaining fluid of interest 414 includes the further remaining fluid, the viscosity measurement analyzer 210 measures viscosity of the further remaining fluid of interest and/or performs the error correction until the viscosity measurements of all of the further remaining fluid of interest is successful and complete.

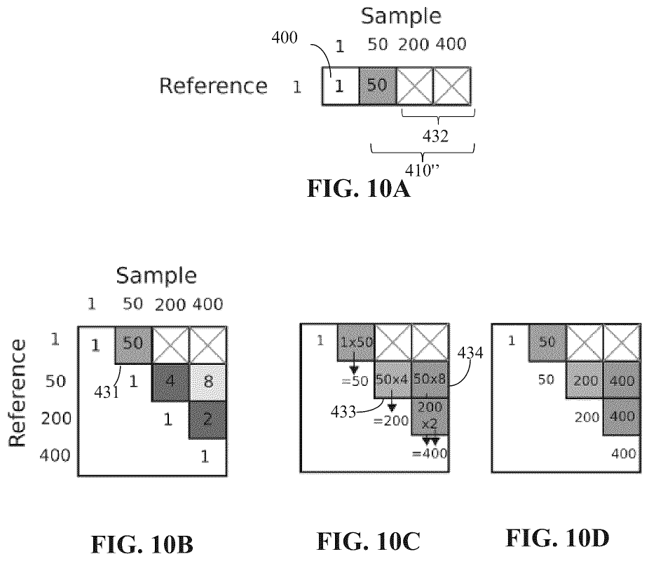

Optionally, the multiple comparison analysis can be used for making viscosity measurements of one or more fluids of interest having high viscosities. FIGS. 10A-D illustrate such measurements of three fluids of interest 410″ having high viscosities of 50 cP, 200 cP, and 400 cP, if measured accurately, using the multiple comparison analysis. It is to be understood that a sample fluid having high viscosity of more than 50× of the viscosity of the reference fluid is considered to be beyond the measurable viscosity range of the reference fluid. As such, the fluid 400 having known viscosity of 1 cP cannot be used as the reference fluid for measuring viscosities of the fluids of interest having high viscosities of 200 cP and 400 cP. FIG. 10A illustrates the failed viscosity measurements of two fluids of interest 432 having high viscosities beyond the measurable viscosity range of the fluid with known viscosity 400 as the reference fluid when the single comparison analysis is applied. FIGS. 10B-D illustrate successful viscosity measurements of the high viscosity fluids of interest 432 using the multiple comparison analysis. To make the viscosity measurements of the high viscosity fluids of interest, the high viscosity detector 227 is utilized. The high viscosity detector 227 is configured to detect if the plurality of fluids of interest 410″ comprises a first fluid of interest 431 having a viscosity within the measurable viscosity range of the reference fluid 400 and a second fluid of interest 432 having a viscosity beyond the measurable viscosity range of the reference fluid 400.

First, the reference fluid selector 217 selects the fluid with known viscosity 400 as the reference fluid. The viscosity calculator 216 then calculates the viscosity parameters including at least flow rates Q of the plurality of fluids, distances L travelled by the plurality of fluids of interest 410″, and a viscosity ratio

$$\frac{{η}_{sample}}{{η}_{ref}}$$

between the viscosity ηₛₐₘₚₗₑ of the plurality of fluids of interest 410″ and the viscosity η_{ref} of the reference fluid 400, and measures the viscosities of the plurality of fluids of interest 410″. The high viscosity detector 227 then detects if the plurality of fluids of interest 410″ comprises a first fluid of interest 431 having a viscosity within a measurable viscosity range of the reference fluid 400 and a second fluid of interest 432 having a viscosity beyond the measurable viscosity range the reference fluid 400. Based on the determination that the plurality of fluids of interest 410″ comprises the first fluid 431 and the second fluid 432, the reference fluid selector 217 selects the first fluid of interest 421 as a new reference fluid. The viscosity calculator 216 then calculates the viscosity parameters including at least flow rates Q of the second fluid of interest and the new reference fluid 431, distances L travelled by the second fluid of interest 432 and the new reference fluid 431, and a viscosity ratio

$$\frac{{η}_{sample}}{{η}_{ref}}$$

between the viscosity ηₛₐₘₚₗₑ of the second fluid of interest 432 and the viscosity η_{ref} of the new reference fluid 431, and measures the viscosity of the second fluid of interest 432. The viscosity measurement analyzer 210 then determines if the second fluid of interest 432 includes a third fluid of interest 433 whose viscosity measurement is complete and remaining fluid of interest 434 whose viscosity measurement is not yet complete using the new reference fluid 431.

Optionally, based on a determination that the second fluid of interest 432 does not includes the third fluid of interest 433 and the remaining fluid of interest 434, the viscosity measurement analyzer 210 determines that the viscosity measurements of all of the plurality of the fluids of interest 410″ have been successful and complete. Alternatively, and optionally, based on a determination that the second fluid of interest 432 includes the third fluid of interest 433 and the remaining fluid of interest 434, the reference fluid selector 217 selects the third fluid of interest 433 as the new reference fluid. Upon selection of the third fluid of interest 433 as the new reference, the viscosity calculator 216 measures the viscosity of the remaining fluid of interest 434 using the new reference fluid 433. The matrix generator 224 then determines if the viscosities of the remaining fluid of interest 434 measured using the first fluid of interest 431 and the second fluid of interest 432 correlate. Based on a determination that the viscosities of the remaining fluid of interest 434 measured using the first fluid of interest 431 and the second fluid of interest 432 as the correlate, the viscosity measurement analyzer 210 determines that the viscosity measurement of the remaining fluid of interest 434 has been successful based at least in part on the correlation. Next, the viscosity measurement analyzer 210 determines if the remaining fluid of interest 434 comprises a further remaining fluid of interest whose viscosity is beyond the measurable range of the reference fluid 400. Based on a determination that the remaining fluid of interest 434 does not comprise the further remaining fluid of interest, the viscosity measurement analyzer 210 determines that the viscosity measurements of all of the remaining fluids of interest has been successful and complete. Alternatively, based on a determination that the remaining fluid of interest 434 comprises the further remaining fluid of interest, the viscosity measurement analyzer 210 measures the viscosity of the further remaining fluid of interest until the viscosity measurement of all of the further remaining fluid of interest has been successful and complete.

Optionally, the viscosity measurement analyzer 210 may include an imaging manager 211. Optionally, the imaging manager 211 includes an image aligner 212 that is configured to automatically detect and align positions of the microfluidic channels 111-116 independently of the position of the microfluidic device 100 in the fields of view of the imaging device 200. Optionally, the imaging manager 211 includes a background corrector 213 configured to reduce influence of a background from the images of the fluid flows. The background correct 213 is, optionally a rolling ball algorithm configured to reduce the influence of the background for better visualization of the microfluidic channels 111-116. Optionally, the imaging manager 211 includes a thresholding element 214 configured to replace all values corresponding to the background with a black pixel for image segmentation. Optionally, the imaging manager 211 includes a filtering element 215 configured to filter out the background and noises from the acquired images of the fluid flows. Optionally, the filtering element 215 is, e.g., Gaussian blur, minimum, maximum or variance that provides for enhanced visualization of flow rates Q.

Optionally, the viscosity measurement analyzer 210 may include a non-Newtonian behavior detector 229 configured to automatically detect non-Newtonian behavior of a fluid(s) of interest based at least in part on flow rates Q as developed for Newtonian fluids and estimate parameters including a power-law exponent of the non-Newtonian fluid of interest. A fluid whose viscosity is not independent of the shear rates applied is non-Newtonian. That is, a non-Newtonian fluid can exhibit an increase or decrease of viscosity as a function of shear rate. Optionally, the viscosity measurement analyzer 210 may include a non-Newtonian fluid viscosity calculator configured to determine a power-law exponent of a non-Newtonian fluid of interest and calculate the viscosity of the non-Newtonian fluid of interest based at least in part on the estimated parameters. Optionally, the viscosity calculator 216 calculates the power-law component and measures the viscosity of the non-Newtonian fluid based at least in part on the estimated parameters of the non-Newtonian fluid.

The following exemplary embodiments further describe optional aspects of the presently disclosed technology and are part of this Detailed Description. These exemplary embodiments are set forth in a format substantially akin to claims (each with numerical designations followed by a letter), although they are not technically claims of the present application. The following exemplary embodiments refer to each other in dependent relationships as “embodiments” instead of “claims.”

1A. A microfluidic viscometer comprising:
a microfluidic device having a glass layer and a polydimethylsiloxane (PDMS) layer attached on top of the glass layer, the PDMS layer having a vacuum cavity and a plurality of microfluidic channels each having inlets at one end and being coupled to one another via the vacuum cavity at distal end, the microfluidic channels being configured to convey a plurality of fluids from respective inlets to the distal end upon introduction of the plurality of fluids to the inlets, the plurality of fluids comprising a fluid with known viscosity and a fluid of interest with unknown viscosity; and
an imaging device configured to automatically and continuously acquire images of fluid flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure the viscosity of the fluid of interest based at least in part on the analyzed and compared viscosity parameters.

2A. The microfluidic viscometer pf embodiment 1A, wherein the viscosity measurement analyzer comprises:
a reference fluid selector configured to select a reference fluid from the plurality of fluids; and
a viscosity calculator configured to calculate the viscosity parameters of the plurality of fluids upon introduction of last fluid of the plurality of fluids and measure the viscosity of the fluid of interest based at least in part on the viscosity parameters.

3A. The microfluidic viscometer of embodiment 1A or 2A, wherein the viscosity parameters comprise at least one of flow rates Q of the plurality of fluids, distances L travelled by the plurality of fluids, and a ratio

$$\frac{{η}_{sample}}{{η}_{ref}}$$

of the viscosity ηₛₐₘₚₗₑ of the fluid of interest to a viscosity η_{ref} of the reference fluid, where the flow rates

$$Q = \frac{Δ P}{{R}_{H}} = Δ P \frac{{A}^{2}}{η {LC}_{geom}} , the ratio \frac{{η}_{sample}}{{η}_{ref}} = \frac{{Q}_{ref} {L}_{ref}}{{Q}_{sample} {L}_{sample}} ,$$

ΔP is pressure drop between the one end and the distal end, R_{H} is hydraulic resistance to flow, A is area of the cross section of each microfluidic channel, C_{geom} is the constant related to channel geometry, η is the viscosity of a fluid, η_{ref} is the viscosity of the reference fluid, ηₛₐₘₚₗₑ is the viscosity of the fluid of interest, Q_{ref} is the flow rate of the reference fluid, Qₛₐₘₚₗₑ is the flow rate of the fluid of interest, L_{ref} is the distance travelled by the reference fluid, and Lₛₐₘₚₗₑ is the distance travelled by the fluid of interest.

4A. The microfluid viscometer of embodiments 1A-3A, wherein the fluid of interest comprises a single fluid of interest, wherein the reference fluid selector selects the fluid of known viscosity as the reference fluid, and wherein the viscosity calculator simultaneously calculates the viscosity parameters of the plurality of fluids, analyzes and compares calculated viscosity parameters, and measures the viscosity of the fluid of interest based at least in part on the analyzed and compared viscosity parameters.

5A. The microfluidic viscometer of embodiments 1A-3A, wherein the fluid of interest comprises a plurality of fluids of interest, wherein the reference fluid selector selects the fluid with known viscosity as the reference fluid, and wherein the viscosity calculator simultaneously calculates the viscosity parameters of the plurality of fluids and measures viscosities of the plurality of fluids of interest using the viscosity η_{ref} of the reference fluid and viscosity ratios

$$\frac{{η}_{sample}}{{η}_{ref}}$$

between the viscosities ηₛₐₘₚₗₑ of the plurality of fluids of interest and the viscosity η_{ref} of the reference fluid.

6A. The microfluidic viscometer of embodiment 5A, wherein the viscosity measurement analyzer determines that the plurality of fluids of interest comprises a first fluid of interest whose viscosity measurement is complete using the viscosity of the reference fluid and the viscosity ratios between the viscosities of the plurality of fluids of interest and the viscosity of the reference fluid, and a second fluid of interest whose viscosity measurement is not yet complete, wherein the reference fluid selector selects the first fluid of interest as a new reference fluid, and wherein the viscosity calculator simultaneously calculates the viscosity parameters of the plurality of fluids of interest and measures viscosity of the second fluid of interest using the viscosity η_{ref} of the new reference fluid and viscosity ratios

$$\frac{{η}_{sample}}{{η}_{ref}}$$

between the viscosities ηₛₐₘₚₗₑ of the plurality of fluids of interest and the viscosity η_{ref} of the new reference fluid.

7A. The microfluidic viscometer of embodiment 5A or 6A, wherein the viscosity measurement analyzer determines that the second fluid of interest comprises a third fluid of interest whose viscosity measurement is complete using the viscosity of the new reference fluid and the viscosity ratios between the viscosities of the plurality of fluids and the viscosity of the new reference fluid, and remaining fluid of interest whose viscosity measurement is not yet complete; wherein the reference fluid selector selects the third fluid of interest as the new reference fluid; and wherein the viscosity calculator calculates viscosity parameters of the second fluid of interest and measures viscosity of the remaining fluid of interest using the viscosity η_{ref} of the new reference fluid and viscosity ratios

$$\frac{{η}_{sample}}{{η}_{ref}}$$

between the viscosity ηₛₐₘₚₗₑ of the remaining fluid of interest and the viscosity η_{ref} of the new reference fluid.

8A. The microfluidic viscometer of embodiments 5A-7A, wherein the viscosity measurement analyzer further comprises a matrix generator configured to generate a matrix of the viscosity measurements of the plurality of fluids of interest and perform correlation of the viscosity measurements, an error detector configured to detect an error in the viscosity measurements, and an error corrector configured to correct the error, wherein the matrix generator generates a matrix of the viscosity measurements of the plurality of fluids of interest and determines if the viscosities of the remaining fluid of interest measured using the first fluid of interest and the third fluid of interest as the new reference fluid correlate, and wherein based on a determination that the viscosities of the remaining fluid of interest measured using the first fluid of interest and the third fluid of interest as the new reference fluid do not correlate, the viscosity measurement analyzer performs an error correction.

9A. The microfluidic viscometer of embodiments 5A-8A, wherein for the error correction, the error detector detects a viscosity measurement of the remaining fluid of interest that does not correlate with other viscosity measurements of the remaining fluid of interest, and determines that the other viscosity measurements of the remaining fluid of interest are equal; the error corrector excludes the viscosity measurement that does not correlate with the other viscosity measurements of the remaining fluid of interest; and the viscosity calculator measures the viscosity of the remaining fluid of interest using at least one of the new reference fluid and an average of the other viscosity measurements of the remaining fluid of interest.

10A. The microfluidic viscometer of embodiment 9A, wherein the viscosity measurement analyzer determines if the remaining fluid of interest comprises a further remaining fluid of interest whose viscosity measurement is not yet complete, and wherein based on a determination that the remaining fluid of interest does not comprise the further remaining fluid of interest, the viscosity measurement analyzer determines that viscosity measurements of all of the fluids of interest have been successful and complete, or wherein based on a determination that the remaining fluid of interest comprises the further remaining fluid of interest, the viscosity calculator measures viscosity of the further fluid of interest and/or performs the error correction until the viscosity measurements of all of the further remaining fluid of interest is complete.

11A. The microfluidic viscometer of embodiment 1A-10A, wherein the vacuum cavity has width of 2 cm and a length of 3.4 cm.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A microfluidic viscometer comprising:
a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and one or more fluids of interest with unknown viscosity; and
an imaging device configured to automatically and continuously acquire images of fluid flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure the viscosity of the one or more fluids of interest based at least in part on the analyzed and compared viscosity parameters.

2. The microfluidic viscometer of claim 1, wherein the microfluidic viscometer has undergone vacuum treatment, and upon exposing the microfluidic device to an ambient air, diffusion of gas molecules in the ambient air into PDMS walls of the microfluidic channels generates a negative pressure that drives the flows of the plurality of fluids through the channels.

3. The microfluidic viscometer of claim 1, wherein the viscosity measurement analyzer comprises:
a reference fluid selector configured to select a reference fluid from the plurality of fluids; and
a viscosity calculator configured to calculate the viscosity parameters of the plurality of fluids upon introduction of last fluid of the plurality of fluids and measure the viscosity of the one or more fluids of interest based at least in part on the viscosity parameters.

4. The microfluidic viscometer of claim 1, wherein the viscosity parameters comprise at least one of flow rates Q of the plurality of fluids, distances L travelled by the plurality of fluids, and a ratio
$$\frac{{η}_{sample}}{{η}_{ref}}$$
of the viscosity ηₛₐₘₚₗₑ of each fluid of interest to a viscosity η_{ref} of the reference fluid, where the flow rates
$$Q = \frac{Δ P}{{R}_{H}} = Δ P \frac{{A}^{2}}{η {LC}_{geom}} , the ratio \frac{{η}_{sample}}{{η}_{ref}} = \frac{{Q}_{ref} {L}_{ref}}{{Q}_{sample} {L}_{sample}} ,$$
ΔP is pressure drop between the one end and the distal end, R_{H} is hydraulic resistance to flow, A is area of the cross section of each microfluidic channel, C_{geom} is the constant related to channel geometry, η is the viscosity of a fluid, η_{ref} is the viscosity of the reference fluid, ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest.

5. The microfluidic viscometer of claim 3, wherein the one or more fluids of interest comprise a single fluid of interest,
wherein the reference fluid selector selects the fluid of known viscosity as the reference fluid, and
wherein the viscosity calculator simultaneously calculates the viscosity parameters of the plurality of fluids, analyzes and compares calculated viscosity parameters, and measures the viscosity of the single fluid of interest based at least in part on the analyzed and compared viscosity parameters.

6. The microfluidic viscometer of claim 5, wherein the viscosity measurement analyzer comprises a parameter plotter configured to plot the flow rate Q_{ref} multiplied by the distance L_{ref} of the reference fluid with respect to the flow rate Qₛₐₘₚₗₑ multiplied by the distance Lₛₐₘₙₚₗₑ of the single fluid of interest, and a data fitter configured to fit data including the viscosity parameters and the plotted viscosity parameters over a plurality of points in time, and wherein the viscosity calculator measures the viscosity of the single fluid of interest based at least in part on the data fitted by the data fitter.

7. The microfluidic viscometer of claim 5, wherein the viscosity measurement analyzer further comprises a Newtonian behavior detector that is configured to verify Newtonian behavior of the single fluid of interest based on the data fitted over the plurality of points in time, and wherein the viscosity calculator calculates the viscosity of the single fluid of interest based at least in part on the fitted data and the verification of Newtonian behavior of the single fluid of interest.

8. The microfluidic viscometer of claim 1, wherein the one or more fluids of interest comprise a plurality of fluids of interest,
wherein the reference fluid selector selects the at least one fluid with known viscosity as the reference fluid, and
wherein the viscosity calculator simultaneously calculates the viscosity parameters of the plurality of fluids and measures viscosities of the plurality of fluids of interest using the viscosity η_{ref} of the reference fluid and viscosity ratios
$$\frac{{η}_{sample}}{{η}_{ref}}$$
between the viscosities ηₛₐₘₚₗₑ of the plurality of fluids of interest and the viscosity η_{ref} of the reference fluid.

9. The microfluidic viscometer of claim 8, wherein the viscosity measurement analyzer determines that the plurality of fluids of interest comprises a first fluid of interest whose viscosity measurement is complete using the viscosity of the reference fluid and the viscosity ratios between the viscosities of the plurality of fluids of interest and the viscosity of the reference fluid, and a second fluid of interest whose viscosity measurement is not yet complete,
wherein the reference fluid selector selects the first fluid of interest as a new reference fluid, and
wherein the viscosity calculator simultaneously calculates the viscosity parameters of the plurality of fluids of interest and measures viscosity of the second fluid of interest using the viscosity η_{ref} of the new reference fluid and viscosity ratios
$$\frac{{η}_{sample}}{{η}_{ref}}$$
between the viscosities ηₛₐₘₚₗₑ of the plurality of fluids of interest and the viscosity η_{ref} of the new reference fluid.

10. The microfluidic device of claim 9, wherein the viscosity measurement analyzer determines that the second fluid of interest comprises a third fluid of interest whose viscosity measurement is complete using the viscosity of the new reference fluid and the viscosity ratios between the viscosities of the plurality of fluids and the viscosity of the new reference fluid, and remaining fluid of interest whose viscosity measurement is not yet complete;
wherein the reference fluid selector selects the third fluid of interest as the new reference fluid; and
wherein the viscosity calculator calculates viscosity parameters of the second fluid of interest and measures viscosity of the remaining fluid of interest using the viscosity η_{ref} of the new reference fluid and viscosity ratios
$$\frac{{η}_{sample}}{{η}_{ref}}$$
between the viscosity ηₛₐₘₚₗₑ of the remaining fluid of interest and the viscosity η_{ref} of the new reference fluid.

11. The microfluidic viscometer of claim 9, wherein the viscosity measurement analyzer further comprises a matrix generator configured to generate a matrix of the viscosity measurements of the plurality of fluids of interest and perform correlation of the viscosity measurements, an error detector configured to detect an error in the viscosity measurements, and an error corrector configured to correct the error,
wherein the matrix generator generates a matrix of the viscosity measurements of the plurality of fluids of interest and determines if the viscosities of the remaining fluid of interest measured using the first fluid of interest and the third fluid of interest as the new reference fluid correlate, and
wherein based on a determination that the viscosities of the remaining fluid of interest measured using the first fluid of interest and the third fluid of interest as the new reference fluid do not correlate, the viscosity measurement analyzer performs an error correction.

12. The microfluidic viscometer of claim 11, wherein for the error correction,
the error detector detects a viscosity measurement of the remaining fluid of interest that does not correlate with other viscosity measurements of the remaining fluid of interest, and determines that the other viscosity measurements of the remaining fluid of interest are equal;
the error corrector excludes the viscosity measurement that does not correlate with the other viscosity measurements of the remaining fluid of interest; and
the viscosity calculator measures the viscosity of the remaining fluid of interest using at least one of the new reference fluid and an average of the other viscosity measurements of the remaining fluid of interest.

13. The microfluidic viscometer of claim 12, wherein the viscosity measurement analyzer determines if the remaining fluid of interest comprises a further remaining fluid of interest whose viscosity measurement is not yet complete, and
wherein based on a determination that the remaining fluid of interest does not comprise the further remaining fluid of interest, the viscosity measurement analyzer determines that viscosity measurements of all of the fluids of interest have been successful and complete, or
wherein based on a determination that the remaining fluid of interest comprises the further remaining fluid of interest, the viscosity calculator measures viscosity of the further remaining fluid of interest and/or performs the error correction until the viscosity measurements of all of the further remaining fluid of interest is complete.

14. The microfluidic viscometer of claim 8, wherein the viscosity measurement analyzer further comprises a matrix generator configured to generate a matrix of viscosity measurements of the plurality of fluids of interest and perform correlation of the viscosity measurements and a high viscosity detector configured to determine if the plurality of fluids of interest comprises a first fluid of interest having a viscosity within a measurable viscosity range of the reference fluid and a second fluid of interest having a viscosity beyond the measurable viscosity range of the reference fluid.

15. The microfluidic viscometer of claim 14, wherein the high viscosity detector determines that the plurality of fluids comprises the first fluid of interest and the second fluid of interest,
wherein based on the determination that the plurality of fluids of interest comprises the first fluid and the second fluid, the reference fluid selector selects the first fluid of interest as a new reference fluid, and
wherein the viscosity calculator calculates the viscosity parameters including at least flow rates Q of the second fluid of interest and the new reference fluid, distances L travelled by the second fluid of interest and the new reference fluid, and a viscosity ratio
$$\frac{{η}_{sample}}{{η}_{ref}}$$
between the viscosity ηₛₐₘₚₗₑ of the second fluid of interest and the viscosity η_{ref} of the new reference fluid, and measures the viscosity of the second fluid of interest.

16. The microfluidic viscometer of claim 15, wherein the viscosity measurement analyzer determines if the second fluid of interest comprises a third fluid of interest whose viscosity measurement is complete using the new reference fluid and remaining fluid of interest whose viscosity measurement could not be made using the new reference fluid,
wherein based on a determination that the second fluid of interest does not comprise the third fluid of interest and the remaining fluid of interest, the viscosity measurement analyzer determines that the viscosity measurements of all of the plurality of the fluids of interest have been successful and complete, or
wherein based on a determination that the second fluid of interest comprises the third fluid of interest and the remaining fluid of interest, the reference fluid selector selects the third fluid of interest as the new reference fluid,
upon the selection of the third fluid of interest as the new reference, the viscosity calculator measures the viscosity of the remaining fluid of interest using the new reference fluid;
upon the measurement of the viscosity of the remaining fluid of interest using the new reference fluid, the matrix generator determines if the viscosities of the remaining fluid of interest measured using the first fluid of interest and the second fluid of interest as the new reference fluid correlate; and
based on a determination that the viscosities of the remaining fluid of interest measured using the first fluid of interest and the second fluid of interest as the new reference fluid correlate, the viscosity measurement analyzer determines that the viscosity measurement of the remaining fluid of interest has been successful based at least in part on the correlation.

17-33. (canceled)

34. A method of measuring viscosities of a plurality of fluids, the method comprising:
providing a microfluidic viscometer that comprises (i) a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and one or more fluids of interest with unknown viscosity, and (ii) an imaging device configured to automatically and continuously acquire images of flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure the viscosities of the one or more fluids of interest based at least in part on the analyzed and compared viscosity parameters;
acquiring, by the imaging device, images of the flows of the plurality of fluids within the microfluidic channels; and
measuring, by the viscosity measurement analyzer, the viscosities of the one or more fluids of interest based at least in part on the acquired images.

35.-62. (canceled)

63. A method of measuring viscosities of a plurality of fluids, the method comprising:
providing a microfluidic viscometer that comprises (i) a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and a plurality of fluids of interest with unknown viscosity, and (ii) an imaging device configured to automatically and continuously acquire images of flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure the viscosity of the plurality of fluids of interest based at least in part on the analyzed and compared viscosity parameters;
introducing the plurality of fluids to the inlets of the microfluidic device;
acquiring, by the imaging device, images of the flows of the plurality of fluids within the microfluidic channels;
selecting, by a reference fluid selector of the viscosity measurement analyzer, the at least one fluid with known viscosity as a reference fluid;
calculating simultaneously, by a viscosity calculator of the viscosity measurement analyzer, the viscosity parameters including at least flow rates Q of the plurality of fluids, distances L travelled by the plurality of fluids, and viscosity ratios
$$\frac{{η}_{sample}}{{η}_{ref}}$$
between the viscosities ηₛₐₘₚₗₑ of the plurality of fluids of interest and the viscosity η_{ref} of the reference fluid, where the flow rates
$$Q = \frac{Δ P}{{R}_{H}} = Δ P \frac{{A}^{2}}{η {LC}_{geom}} ,$$
the viscosity ratio
$$\frac{{η}_{sample}}{{η}_{ref}} = \frac{{Q}_{ref} {L}_{ref}}{{Q}_{sample} {L}_{sample}} ,$$
ΔP is the pressure drop between the one end and the distal end, R_{H} is hydraulic resistance to flow, A is the area of the cross section of each microfluidic channel, and C_{geom} is a constant related to channel geometry and ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest; and
measuring, by the viscosity calculator, the viscosities of the plurality of fluids of interest using the viscosity η_{ref} of the reference fluid and viscosity ratios
$$\frac{{η}_{sample}}{{η}_{ref}}$$
between the viscosities ηₛₐₘₚₗₑ of the plurality of fluids of interest and the viscosity η_{ref} of the reference fluid.

64. (canceled)

65. (canceled)

66. (canceled)

67. A method of automatically correcting an error in viscosity measurements of a plurality of fluids of interest, comprising:
providing a microfluidic viscometer that comprises (i) a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and a plurality of fluids of interest with unknown viscosity, and (ii) an imaging device configured to automatically and continuously acquire images of flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure the viscosities of the plurality of fluids of interest based at least in part on the analyzed and compared viscosity parameters;
introducing the plurality of fluids to the inlets of the microfluidic device;
acquiring, by the imaging device, images of the fluid flows of the plurality of fluids within the microfluidic channels;
selecting, by a reference fluid selector of the viscosity measurement analyzer, the at least one fluid with known viscosity as a reference fluid;
calculating simultaneously, by a viscosity calculator of the viscosity measurement analyzer, the viscosity parameters including at least flow rates Q of the plurality of fluids, distances L travelled by the plurality of fluids, and viscosity ratios
$$\frac{{η}_{sample}}{{η}_{ref}}$$
between the viscosities ηₛₐₘₚₗₑ of the plurality of fluids of interest and the viscosity η_{ref} of the reference fluid, where the flow rates
$$Q = \frac{Δ P}{{R}_{H}} = Δ P \frac{{A}^{2}}{η {LC}_{geom}} ,$$
the viscosity ratio
$$\frac{{η}_{sample}}{{η}_{ref}} = \frac{{Q}_{ref} {L}_{ref}}{{Q}_{sample} {L}_{sample}} ,$$
ΔP is the pressure drop between the one end and the distal end, R_{H} is hydraulic resistance to flow, A is the area of the cross section of each microfluidic channel, and C_{geom} is a constant related to channel geometry and ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest;
measuring, by the viscosity calculator, the viscosities of the plurality of fluids of interest using the viscosity η_{ref} of the reference fluid and viscosity ratios
$$\frac{{η}_{sample}}{{η}_{ref}}$$
between the viscosities ηₛₐₘₚₗₑ of the plurality of fluids of interest and the viscosity η_{ref} of the reference fluid; and
correcting an error in the measured viscosities of the plurality of fluids of interest.

68. (canceled)

69. (canceled)

70. (canceled)

71. (canceled)

72. A method of measuring a plurality of fluids of interest including a fluid of interest having a high viscosity, comprising:
providing a microfluidic viscometer that comprises (i) a microfluidic device having a glass layer and a polydimethylsiloxane (PDMS) layer attached on top of the glass layer, the PDMS layer having a plurality of microfluidic channels each having inlets at one end and being coupled to one another via a single chamber at distal end, the microfluidic channels being configured to convey a plurality of fluids from respective inlets to the distal end upon introduction of the plurality of fluids to the inlets, the plurality of fluids comprising at least one fluid with known viscosity and a plurality of fluids of interest with unknown viscosity, and (ii) an imaging device configured to automatically and continuously acquire images of flows within the microfluidic channels upon the introduction of the plurality of fluids, the imaging device having a viscosity measurement analyzer configured to automatically calculate viscosity parameters of the plurality of fluids based at least in part on the acquired images, analyze and compare the viscosity parameters, and measure the viscosity of the plurality of fluids of interest based at least in part on the analyzed and compared viscosity parameters;
introducing the plurality of fluids to the inlets of the microfluidic device;
acquiring, by the imaging device, images of the flows of the plurality of fluids within the microfluidic channels;
selecting, by a reference fluid selector of the viscosity measurement analyzer, the at least one fluid with known viscosity as a reference fluid;
calculating simultaneously, by a viscosity calculator of the viscosity measurement analyzer, the viscosity parameters including at least flow rates Q of the plurality of fluids, distances L travelled by the plurality of fluids, and viscosity ratios
$$\frac{{η}_{sample}}{{η}_{ref}}$$
between the viscosities ηₛₐₘₚₗₑ of the plurality of fluids of interest and the viscosity η_{ref} of the reference fluid, where the flow rates
$$Q = \frac{Δ P}{{R}_{H}} = Δ P \frac{{A}^{2}}{η {LC}_{geom}} ,$$
the viscosity ratio
$$\frac{{η}_{sample}}{{η}_{ref}} = \frac{{Q}_{ref} {L}_{ref}}{{Q}_{sample} {L}_{sample}} ,$$
ΔP is the pressure drop between the one end and the distal end, R_{H} is hydraulic resistance to flow, A is the area of the cross section of each microfluidic channel, and C_{geom} is a constant related to channel geometry and ηₛₐₘₚₗₑ is the viscosity of each fluid of interest, Q_{ref} is the flow rate of the reference fluid, Qₛₐₘₚₗₑ is the flow rate of each fluid of interest, L_{ref} is the distance travelled by the reference fluid, and Lₛₐₘₚₗₑ is the distance travelled by each fluid of interest;
measuring, by the viscosity calculator, the viscosities of the plurality of fluids of interest using the viscosity η_{ref} of the reference fluid and viscosity ratios
$$\frac{{η}_{sample}}{{η}_{ref}}$$
between the viscosities ηₛₐₘₚₗₑ of the plurality of fluids of interest and the viscosity η_{ref} of the reference fluid; and
determining by, a high viscosity detector of the viscosity measurement analyzer, if the plurality of fluids of interest comprises a first fluid of interest having a viscosity within a measurable viscosity range of the reference fluid and a second fluid of interest having a viscosity beyond the measurable viscosity range of the reference fluid.

73. (canceled)

74. (canceled)

75. (canceled)
